(19) United States
(12) Patent Application Publication
(10) Pub. No.: US 2011/0276757 A1
(43) Pub. Date: Nov. 10, 2011

(54) STORAGE CONTROL DEVICE, AND CONTROL METHOD FOR CACHE MEMORY

(75) Inventors: Kazue Jindo, Odawara (JP); Isamu Kurokawa, Odawara (JP); Akihiro Mori, Odawara (JP); Junichi Muto, Odawara (JP); Ran Ogata, Odawara (JP)

(73) Assignee: Hitachi, Ltd., Tokyo (JP)

(21) Appl. No.: 12/377,305

(22) PCT Filed: Feb. 3, 2009
(86) PCT No.: PCT/JP2009/000416

§ 371 Date: Feb. 12, 2009

(51) Int. Cl. G06F 12/08; G06F 12/00

(52) U.S. Cl. 711/113; 711/E12.019

(57) ABSTRACT

The storage control device of the present invention uses a plurality of queues to manage cache segments which are in use, so as to retain cache segments which contain large amounts of data for long periods of time. One of the queues manages segments in which large amounts of valid data are stored. Another queue manages segments in which small amounts of valid data are stored. If the number of unused segments becomes insufficient, then a segment which is positioned at the LRU end of the other queue is released, and is shifted to a free queue. Due to the use of this other queue, it is possible to retain segments in which comparatively large amounts of data are stored for comparatively long periods of time.

### TECHNICAL FIELD

The present invention relates to a storage control device, and to a control method for a cache memory.

### BACKGROUND ART

A storage control device uses a plurality of storage devices such as hard disk drives, and supplies a storage region to a host computer on the basis of RAID (Redundant Array of Inexpensive Disks). A cache memory is used in transfer of data between the host computer and the storage devices. When a write command is outputted from the host computer, the data is written to a storage device after having been temporarily stored in the cache memory. And when a read command is outputted from the host computer, data which has been read out from the storage device is supplied to the host computer via the cache memory.

The LRU (Least Recently Used) algorithm is per se known as one algorithm for managing the cache memory. In the LRU algorithm, if the vacant capacity in the cache memory has become low, then this vacant capacity is increased by throwing away that data for which the elapsed time from when it was last used is the longest. In other words, among a plurality of segments which are present within the cache memory, the segments in which is stored data which is used the least is released as an unused segment, and subsequently new data is stored therein.

The effectiveness of the LRU algorithm decreases if the access by the host computer is random access, and moreover if the access size of the host computer is smaller than the segment size.

The hit rate decreases the more, the smaller is the access size of the host computer as compared to the segment size. For example, it will be supposed that one segment consists of eight 8 KB blocks, so that the segment size is 64 KB (=8 KB×8). Moreover, it will be supposed that the minimum size for random access by the host is one block.

Segments are used according to the occurrence of random accesses. In the extreme case, sometimes it happens that only 8 KB of data is stored in a segment of 64 KB. The proportion which the data occupies in this segment does not exceed 8/64=⅛. In this manner, the more segments occur in which the proportion of data is low, the more does the efficiency of utilization of the cache memory decrease, and as a result the hit rate decreases.

Due to this, a prior art technique described in Patent Document JP-A-2002-251322 has proposed the provision of a plurality of cache memories which can be set to different segment sizes. With this prior art technique, the size of an access from the host computer is detected, and that cache memory is selected which has a segment size appropriate for this access size which has been detected. Thus, with this prior art technique, it is aimed to enhance the hit rate by bringing the segment sizes and the size of accesses by the host computer closer to one another.
Patent Citation 1: JP-A-2002-251322

### DISCLOSURE OF INVENTION

### Technical Problem

With the above described prior art technique, it is necessary to provide a plurality of cache memories of different segment sizes, and moreover it is necessary to select a segment size for each I/O (Input/Output) by the host computer. Due to this, with this prior art technique, the structure becomes complicated.

Moreover, if the segment size is made small to match the size of an access by the host computer, then the number of segments increases. Accordingly, the size of the management table for managing the segments becomes great, so that the efficiency of utilization of the cache memories decreases. Since the management table is stored by using a portion of the cache memory, accordingly the greater the size of the management table becomes, the smaller does the region for storing user data become.

Thus, one object of the present invention is to provide a storage control device, and a control method for a cache memory, which make it possible to enhance the efficiency of utilization of the cache memory, without changing the segment size. Another object of the present invention is to provide a storage control device, and a control method for a cache memory, which make it possible to enhance the efficiency of utilization of the cache memory and to enhance the hit rate, if the host computer performs random accesses at a smaller size than the segment size. Other objects of the present invention will become clear from the following description.

### Technical Solution

In order to solve the problems described above, according to a first aspect of the present invention, there is proposed a storage control device which performs data input and output between a host computer and a storage device via a cache memory, comprising: a cache control unit for controlling data input and output to and from a plurality of segments which the cache memory possesses; and a plurality of queues which are used by the cache control unit for managing the segments; wherein, in pre-determined circumstances, by controlling the queues according to the amounts of data stored in the segments, the cache control unit permutes segments in which the data amounts are relatively small, so as to give priority to segments whose data amounts are relatively large.

And, according to a second aspect of the present invention, in the first aspect, the plurality of queues includes a first queue for managing segments in which the amount of data is relatively large, a second queue for managing segments in which the amount of data is relatively small, and a third queue for managing unused segments; the predetermined circumstances are that the size of accesses by the host computer is smaller than the size of the segments, and moreover that the host computer performs random accesses; and the cache control unit: if data requested by the host computer is not stored in any of the segments, stores the data requested by the host computer in an unused segment which is being managed with the third queue, and manages the segment with the second queue; if the data requested by the host computer is stored in one of the segments, manages the segment in which the data is stored with the first queue; and, if the number of the unused segments which are being managed with the third queue has become less than or equal to a predetermined value, manages with the third queue as an unused segment, that segment, among the segments being managed with the second queue, for which the elapsed time from its last use is the longest.

And, according to a third aspect of the present invention, in the first aspect, the pre-determined circumstances are that the size of accesses by the host computer is smaller than the size of the segments, and moreover that the host computer performs random accesses.

And, according to a fourth aspect of the present invention, in the first aspect, the plurality of queues includes a first queue for managing segments in which the amount of data is relatively large, a second queue for managing segments in which the amount of data is relatively small, and a third queue for managing unused segments.

And, according to a fifth aspect of the present invention, in the fourth aspect, one single queue 105 is divided into two regions and, and the first region is used as the first queue, while the second region is used as the second queue.

And, according to a sixth aspect of the present invention, in the first aspect, the cache control unit: if data requested by the host computer is not stored in any of the segments, stores the data requested by the host computer in an unused segment which is being managed with the third queue, and manages the segment with the second queue as the segment which has been most recently used; and, if the data requested by the host computer is stored in one of the segments, manages the segment in which the data is stored with the first queue as the segment which has been used the longest ago.

And, according to a seventh aspect of the present invention, in the sixth aspect, if the number of the unused segments which are being managed with the third queue has become less than or equal to a predetermined value, the cache control unit manages with the third queue, as an unused segment, that segment, among the segments being managed with the second queue, for which the elapsed time from its last use is the longest.

And, according to an eighth aspect of the present invention, in the sixth aspect, if the number of the unused segments which are being managed with the third queue has become less than or equal to a predetermined value, the cache control unit: compares together a first elapsed time of that segment, among the segments stored in the first queue, which has been used the longest ago, and a second elapsed time of that segment, among the segments stored in the second queue, which has been used the longest ago; and: if the first elapsed time is greater than or equal to the second elapsed time, manages with the third queue, as an unused segment, the segment, among the segments being managed with the first queue, which has been used the longest ago; and, if the first elapsed time is less than the second elapsed time, manages with the third queue, as an unused segment, the segment, among the segments being managed with the second queue, which has been used the longest ago.

And, according to a ninth aspect of the present invention, in the sixth aspect, if the number of the unused segments which are being managed with the third queue has become less than or equal to a predetermined value, the cache control unit calculates the ratio between the number of segments which are being managed with said first queue, and the number of segments which are being managed with the second queue; and manages with the third queue, as an unused segment, either that segment, among the segments being managed with the first queue, which has been used the longest ago, or that segment, among the segments being managed with the second queue, which has been used the longest ago, so that the ratio approaches a target ratio which is set in advance.

And, according to a tenth aspect of the present invention, in the sixth aspect, the storage device includes a high speed storage device whose access speed is relatively high and a low speed storage device whose access speed is relatively low; and, if the number of the unused segments being managed with the third queue is less than or equal to a predetermined value, the cache control unit manages with the third queue, as an unused segment, a segment, among the segments being managed with the second queue, which corresponds to the high speed storage device.

And, according to an eleventh aspect of the present invention, in the first aspect, if the amount of data which is stored in segments being managed with the first queue has dropped below a predetermined value which is set in advance, shifts the segment in which the amount of data has dropped below the predetermined value to the second queue; and, if the amount of data which is stored in segments being managed with the second queue is greater than the predetermined value which is set in advance, shifts the segment in which the amount of data is greater than or equal to the predetermined value to the first queue.

And, according to a twelfth aspect of the present invention, in the first aspect: each of the segments consists of a plurality of blocks; each of the blocks consists of a plurality of sub-blocks; when predetermined data which has been requested from the host computer is not stored in any one of the segments, the cache control unit reads out the predetermined data from the storage device according to either a first mode, a second mode, or a third mode; the first mode is a mode in which only data in a sub-block corresponding to the predetermined data is read out from the storage device and stored in the cache memory; the second mode is a mode in which data from a sub-block corresponding to the predetermined data to the final sub-block in the segment which contains the sub-block is read out from the storage device and stored in the cache memory; and the third mode is a mode in which the data in all of the sub-blocks in the segment which contains a sub-block corresponding to the predetermined data is read out from the storage device and stored in the cache memory; and the cache control unit: if the predetermined data has been read out in the first mode, manages the segment in which the predetermined data is stored with the second queue; and, if the predetermined data has been read out in the second mode or the third mode, manages the segment in which the predetermined data is stored with the first queue.

And, according to a thirteenth aspect of the present invention, in the first aspect, in other than the predetermined circumstances, the cache control unit releases and reuses segments, among the segments, in order from that segment for which the elapsed time since its last use is the longest.

And, according to a fourteenth aspect of the present invention, a control method for a cache memory is for performing data input and output between a host computer and a storage device via a cache memory, and: the size of accesses by the host computer is smaller than the size of segments which make up the cache memory; a decision is made as to whether or not data to which access has been requested from the computer is stored in any of the segments; if the data to which access has been requested from the computer is stored in one of the segments, the segment in which the data is stored is shifted to a first queue for managing segments in which the proportion of data which has been staged is relatively large; if the data to which access has been requested from the computer is not stored in one of the segments, a decision is made as to whether or not any unused segment exists; if such an unused segment exists, the data to which access has been requested from the computer is read out from the storage device and stored therein, and the segment in which the data which has been read out from the storage device has been stored is put at the newest end of a second queue for managing segments in which the proportion of data which has been staged is relatively small; and, if such an unused segment does not exist, then either that segment, among the segments which are being managed with the first queue, for which the elapsed time from last access is the longest, or that segment, among the segments which are being managed with the second queue, for which the elapsed time from last access is the longest, is used as the unused segment.

Any one, any number, or all of the means, functions or steps of the present invention may be implemented in the form of a computer program which is executed by a computer system. If, in this manner, any one, any number, or all of the structure of the present invention is implemented in the form of a computer program, then this computer program may be fixed upon any of various types of storage medium and thereby distributed, or may be transmitted via a communication network.

Furthermore, the various aspects of the present invention described above may be combined in various manners other than those explicitly described above, and such combinations are also to be considered as falling within the scope of the present invention.

### BRIEF DESCRIPTION OF THE DRAWINGS

FIG. 1 is a conceptual figure showing an embodiment of the present invention.

FIG. 2 is a block diagram of a storage control device.

FIG. 3 is a schematic figure showing the structures of a cache memory and a cache segment.

FIG. 4 is an explanatory figure showing a management method for the cache memory.

FIG. 5 is an explanatory figure showing a table for management of slots and a table for management of segments.

FIG. 6 is an explanatory figure showing the operation of the queues during a segment hit.

FIG. 7 is an explanatory figure showing the operation of the queues during a segment miss.

FIG. 8 is an explanatory figure showing the operation of the queues during re-placement.

FIG. 9 is a flow chart of a cache segment control procedure.

FIG. 10 is a flow chart showing dequeue processing performed during the procedure of FIG. 9.

FIG. 11 is a flow chart showing write command processing.

FIG. 12 is a table showing simulation results which demonstrate the benefits of the present invention.

FIG. 13 is a figure showing a table for deciding priority order for replacement, which is used in a storage control device according to a second embodiment.

FIG. 14 is a flow chart showing a cache segment control procedure.

FIG. 15 is a flow chart showing a cache segment control procedure, which is executed by a storage control device according to a third embodiment.

FIG. 16 is a schematic figure showing a staging mode which is executed by a storage control device according to a fourth embodiment.

FIG. 17 is a flow chart of a cache segment control procedure.

FIG. 18 is a flow chart showing a cache segment control procedure, which is executed by a storage control device according to a fifth embodiment.

FIG. 19 is a flow chart showing processing for selecting a cache control mode, which is executed by a storage control device according to a sixth embodiment.

FIG. 20 is a flow chart showing processing for setting a cache control mode, which is executed by a storage control device according to a seventh embodiment.

FIG. 21 is an explanatory figure showing a device management table and a RAID group management table, which are used by the storage control device according to the seventh embodiment.

FIG. 22 is an explanatory figure showing a tier management table.

FIG. 23 is an explanatory figure showing a setting screen for the cache control mode.

FIG. 24 is an explanatory figure showing the structure of a queue, which is used by a storage control device according to an eighth embodiment.

FIG. 25 is an explanatory figure showing the structure of a queue, which is used by a storage control device according to a ninth embodiment.

### EXPLANATION OF THE REFERENCE SYMBOLS

1 storage control device
2 host computer
4 cache memory
5 logical volume
6 queue for managing low load ratio segments
7 queue for managing high load ratio segments
8 free queue
10 storage control device
100 module
121 microprocessor
130 memory package
132 cache memory
1321 cache segment

### BEST MODES FOR CARRYING OUT THE INVENTION

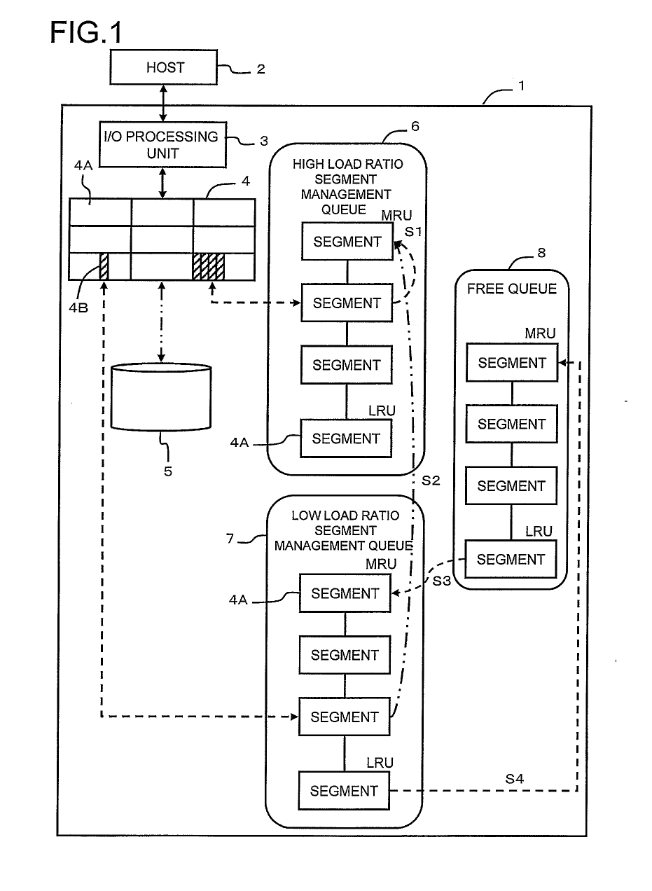

FIG. 1 is an explanatory figure showing a summary of an embodiment of the present invention. The structure shown in FIG. 1 is not to be considered as being limitative of the range of the present invention; other structures than that shown in FIG. 1 are also included within the scope of the present invention. The storage control device 1 according to this embodiment is connected to a host computer 2 (hereinafter abbreviated as the “host”). As such a host 2, for example, there may be cited a computer device such as a server computer, a mainframe computer, an engineering workstation, a personal computer, or the like.

The detailed structure of the storage control device 1 will be further described hereinafter; here, the description will concentrate upon the functions of this storage control device 1. The storage control device 1, for example may comprise an I/O processing unit 3, a cache memory 4, a storage device 5, and a plurality of queues 6, 7, and 8.

The I/O processing unit 3 performs processing to receive write commands and read commands which have been issued from the host 2, and to transmit the results of processing to the host 2.

The cache memory 4 is provided between the host 2 and the storage device 5, and temporarily stores data. This cache memory 4 comprises a plurality of segments 4A. Each of the segments 4A comprises a plurality of blocks 4B. For example, the size of a segment 4A may be 64 KB, while the size of a block 4B may be 8 KB. It should be understood that each of the blocks 4B comprises a plurality of sub-blocks.

The host 2 accesses the blocks 4B, which are of equal size (for example 8 KB); randomly. If data which is desired by the host is not stored in the cache memory 4, then this data is read out from the storage device 5, and is transferred to the cache memory 4. This reading out of data in the storage device 5 and storing it in the cache memory 4 is termed “staging”. And writing of data within the cache memory 4 into the storage device 5 is termed “destaging”.

Various types of device may be used as the storage device 5, such as a hard disk drive, a semiconductor memory drive, an optical disk drive or the like. The storage device 5 may also sometimes be termed the “disk drive 5”.

If a hard disk drive is used as the storage device 5, then, for example, an FC (Fiber Channel) disk, a SCSI (Small Computer System Interface) disk, a SATA disk, an ATA (AT Attachment) disk, a SAS (Serial Attached SCSI) disk, or the like may be used.

If a semiconductor memory is used as the storage device, then various types of memory device may be used, such as, for example, a flash memory device (SSD: Solid State Drive), an FeRAM (Ferroelectric Random Access Memory), a MRAM (Magnetoresistive Random Access Memory), a phase change memory (Ovonic Unified Memory), an RRAM (Resistance RAM), or the like.

A plurality of queues 6 through 8 are implemented for managing the cache memory 4. A “first queue” is a high load ratio segment management queue 6, and this is a queue for managing segments for which staging of data is performed at greater than or equal to a predetermined level. A “second queue” is a low load ratio segment management queue 7, and this is a queue for managing segments for which staging of data is performed at less than the predetermined level. And a “third queue” is a free queue 8, and is a queue for managing segments which are unused. In the figures, sometimes unused segments are shown as being free segments.

The segment which was accessed most long ago is positioned at the head end of each of these queues 6 through 8 (which is its lower end in the figure). By the segment which was accessed most long ago, is meant that segment for which the time which has elapsed since it was last used is the longest, and this segment will sometimes be herein referred to as the “LRU segment” (the Least Recently Used segment). By contrast, the segment which was accessed most recently is positioned at the tail end of each of the queues 6 through 8 (which is its upper end in the figure), and this segment will sometimes be herein referred to as the “MRU segment” (the Most Recently Used segment).

It should be understood that, in the following explanation, for convenience, the high load ratio segment management queue 6 is sometimes termed the “high load ratio” queue 6, and the low load ratio segment management queue 7 is sometimes termed the “low load ratio” queue 7.

The status of data which is stored in a segment can be one of three: “dirty”, “clean”, and “free”. The dirty state is the state of data which has been received from the host 2 before it is written into the storage device 5. Data in the dirty state is only present within the cache memory 4. The clean state is the state of data which has been received from the host 2 after it has been written into the storage device 5. Data in the clean state is present both in the cache memory 4 and in the storage device 5. And the free state means the unused state.

If the number of segments which are being managed in the free queue 8 has become low, then, as described hereinafter, one or more segments which are being managed with the low load ratio queue 7 or the high load ratio queue 6 are shifted to the free queue 8. However, only segments in the free queue for which the data status is the clean state can be shifted to the free queue 8. Thus, segments which contain data which is in the dirty state are not shifted to the free queue 8.

The operation of this embodiment will now be explained in a simple manner. If data which is desired by the host 2 is present in any one of the segments 4A, then this is termed a “segment hit”. If the data which is desired by the host 2 is present within a segment 4A which is being managed with the high load ratio queue 6, then this segment is shifted so as to become the MRU segment of the high load ratio queue 6 (a step S1). And, if the data which is desired by the host 2 is present within a segment 4A which is being managed with the low load ratio queue 7, then this segment is shifted so as to become the MRU segment of the high load ratio queue 6 (a step S2).

If the data which is desired by the host 2 is not present within any of the segments 4A within the cache memory 4, then, among the unused segments which are being managed with the free queue 8, that unused segment which is the LRU segment is selected.

The storage control device 1 reads out the data which is desired by the host 2 from the storage device 5, and stores it in the segment which has been selected. And then this segment in which the data desired by the host 2 has been stored is linked into the low load ratio queue 7 as its MRU segment (a step S3).

In this manner, according to access from the host 2, data which is requested by the host 2 is read out from the storage device 5 and is stored in a segment 4A. If the number of unused segments becomes low, then the segment which is positioned as the LRU segment of the low load ratio queue 7 (a segment which is in the clean state) is shifted to the free queue 8 (a step S4). It should be understood that, as the method of selecting this segment which is returned to the free queue 8, any of a plurality of variant embodiments may be employed. These variant embodiments will be described hereinafter with reference to the figures.

According to this embodiment, the segments 4A are managed according to the amount of data which is being staged in the segments 4A (to put it in another manner, according to the proportion of the segment size which is occupied by the data size). In this embodiment, if the vacant capacity in the cache memory 4 has become low, then a segment 4A in the low load ratio queue 7 is released as an unused segment, and is reused.

Accordingly, in this embodiment, it is possible to keep segments for which the amount of data storage is high for longer periods of time than segments for which the data storage amount is low. Due to this, it is possible to increase the efficiency of utilization of the cache memory 4, and to enhance the hit rate. In the following, embodiments of the present invention will be explained in detail.

### Embodiment 1

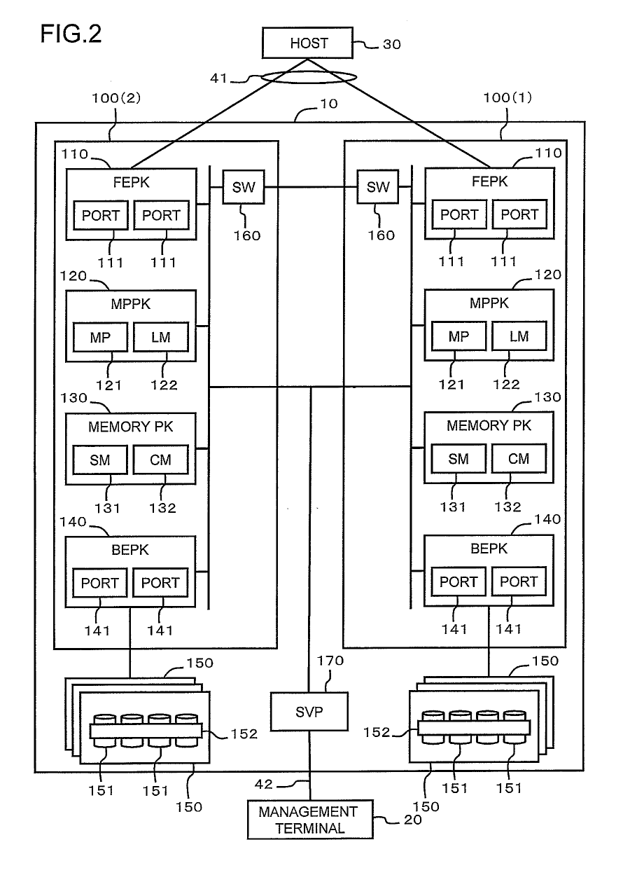

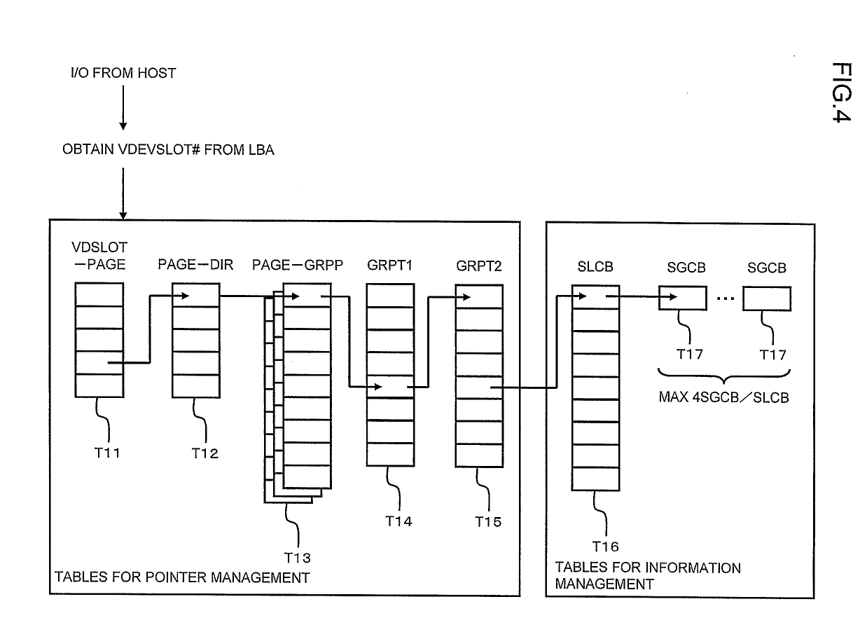

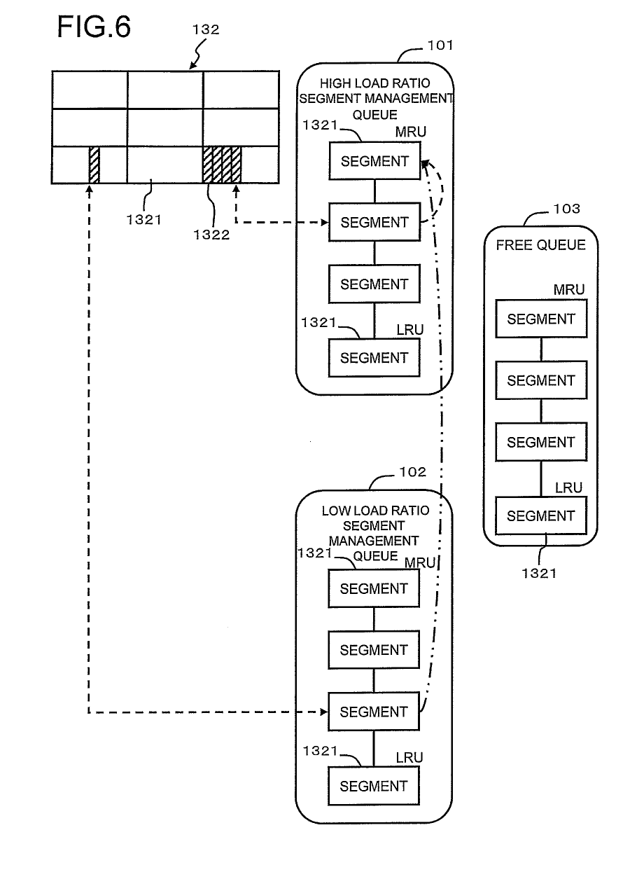

FIG. 2 shows the entire information processing system included in the storage control device 10. First the way this corresponds to FIG. 1 will be explained. The storage control device 10 corresponds to the storage control device 1; the host 30 corresponds to the host 2; the cache memory 132 corresponds to the cache memory 4; the segment 1321 (refer to FIG. 4) corresponds to the segment 4A; the block 1322 (refer to FIG. 4) corresponds to the block 4B; the storage device 151 corresponds to the storage device 5; the queue 101 (refer to FIG. 6) corresponds to the queue 6; the queue 102 (refer to FIG. 6) corresponds to the queue 7; and the queue 103 (refer to FIG. 6) corresponds to the queue 8.

The storage control device 10 comprises two modules 100(1) and 100(2), and one service processor 170 (hereinafter termed the “SVP 170”). When it is not necessary particularly to distinguish between the modules 100(1) and 100(2), reference will be made to a “module 100”.

Each of these modules 100 may comprise, for example, a front end package 110 (in the figure, termed a “FEPK 110”), a microprocessor package 120 (in the figure, termed a “MPPK 120”), a memory package 130 (in the figure, termed a “memory PK” 130), a back end package 140 (in the figure, termed a “BEPK 140”), and a switch 160. And each of the modules 110 can utilize a plurality of corresponding storage devices 151.

The front end package 110 is a control board which is in charge of communication with the host 30. This front end package 110 comprises a plurality of communication ports 111. The communication ports 111 are connected to the host 30 via a communication network 41. For this communication network, for example, a FC_SAN (Fiber Channel_Storage Area Network) or an IP_SAN (Internet Protocol_SAN) may be used.

In the case of a FC_SAN, the communication between the host 30 and the front end package 110 is performed according to a fiber channel protocol. If the host 30 is a mainframe, then, for example, data communication may be performed according to a communication protocol such as FICON (Fiber Connection: registered trademark), ESCON (Enterprise System Connection: registered trademark), ACONARC (Advanced Connection Architecture: registered trademark), FIBARC (Fiber Connection Architecture: registered trademark) or the like. In the case of an IP_SAN, the communication between the host 30 and the front end package 110 is performed according to the TCP/IP (Transmission Control Protocol/Internet Protocol) or the like.

The back end package 140 is a control board which is in charge of communication with the storage devices 151. This back end package 140 comprises a plurality of communication ports 141, and each of the communication ports 141 is connected to the storage devices 151.

The memory package 130 has a shared memory region 131 and a cache memory region 132. In the shared memory region 131 there are stored, for example, commands which have been received from the host 30 and various types of information for control and so on. And in the cache memory region 132 there are stored, for example, user data and tables and so on for managing the cache memory region 132. In the following explanation, the cache memory region 132 will be termed the cache memory 132.

The microprocessor package 120 is a control board for controlling the operation of this module 100. This microprocessor package 120 comprises a microprocessor 121 and a local memory 122.

The microprocessor package 120 executes commands which have been issued by the host 30, and transmits the results of their execution to the host 30. For example, if the front end package 110 has received a read command, then the microprocessor package 120 acquires the data which has been requested from the cache memory 132 or from a storage device 151, and transmits it to the host 30. And, if the front end package 110 has received a write command, then the microprocessor package 120 writes the write data into the cache memory 132, and notifies the host 30 that processing has been completed. This data which has been written into the cache memory 132 is subsequently written into a storage device 151.

Furthermore, the microprocessor package 120 performs queuing management which will be described hereinafter.

As described above, the storage devices 151 are storage devices such as hard disk drives or flash memory devices or the like. A plurality of these storage devices 151 may be collected together into one group 150. This group 150 may be, for example, a so called RAID group or parity group. And one or a plurality of logical volumes are defined in the grouped storage region.

The switches 160 are circuits for connecting the modules 100 together. Thereby, one of the modules 100(1) is able to access the memory package 130 and the storage devices 151 of the other module 100(2) via the switches 160. And, in a similar manner, that other module 100(1) is able to access the memory package 130 and the storage devices 151 of the first module 100(1) via the switches 160.

For example, the case may be investigated in which, when the microprocessor package 120 within one of the modules 100(1) is processing a command from the host 30, the data which is being requested by the host 30 is present in the cache memory 132 or a storage device 151 of the other module 100(2). In this case, the micro-processor package 120 within the first module 100(1) acquires this data from the cache memory 132 or the storage device 151 of the other module 100(2). And the micro-processor package 120 within the first module 100(1) transmits this data which has been acquired to the host 30 via the front end package 110 of this first module 100(1).

The SVP 170 is a control circuit for gathering various types of information within the storage control device 10 and supplying it to a management terminal 20, and for storing set values and so on which have been inputted from the management terminal 20 in a shared memory 131. This SVP 170 is connected to the management terminal 20 via a communication network such as, for example, a LAN (Local Area Network).

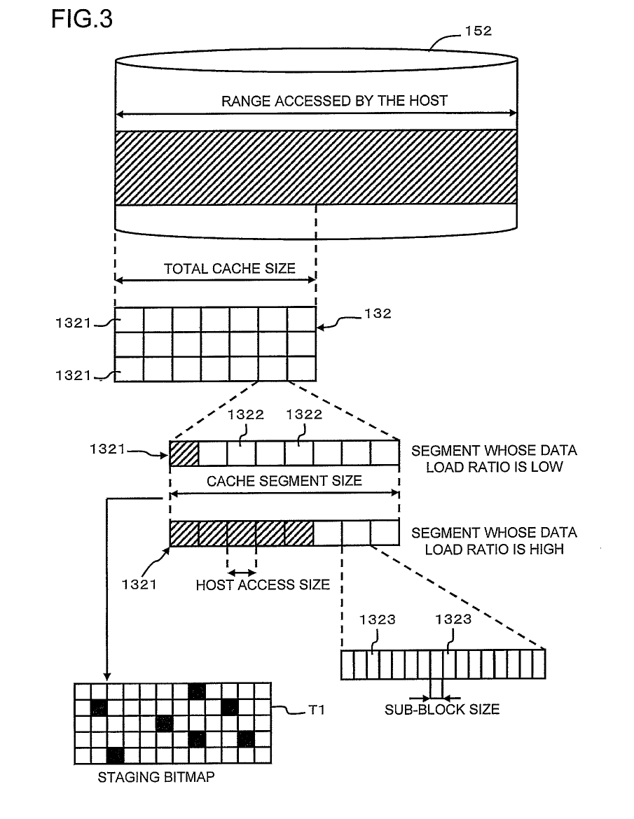

FIG. 3 is an explanatory figure, schematically showing the relationship between the structure of the cache memory 132 and host access size and so on.

The host 30 can access all or a portion of a logical volume 152. The range which the host 30 can access will be termed the “host access range”. In normal circumstances, for reasons such as keeping down the cost of manufacture and so on, the size of the cache memory 132 is set to be smaller than the host access range.

The cache memory 132 is made up of a plurality of segments 1321. The size of each segment 1321 may be, for example, 64 KB. Each of the segments 1321 is made up of a plurality of blocks 1322. The size of each block 1322 may be, for example, 8 KB. In this embodiment, the size of accesses by the host 30 (the host access size) and the block size are equal.

Each of the blocks 1322 is made up of a plurality of sub-blocks 1323. The size of each of the sub-blocks 1323 may be, for example, 512 bytes. A staging bitmap T1 is a table for managing, among the sub-blocks 1323 which are included in each segment 1321, in which of the sub-blocks 1323 the data is valid.

To express this simply, the staging bitmap T1 is a table which shows, for the various sub-blocks which make up a segment 1321, in which sub-blocks 1323 data is stored.

As explained in FIG. 3, the size of the cache memory 132 is small as compared with the host access range, which is the range that the host 30 can access. Furthermore, the host 30 performs random accesses in a size (=the block size=8 KB) which is smaller than the size of the segments 1321. Accordingly, it becomes very important to determine which segments are preferentially left in the cache memory 132, and which segments to release.

Thus, in this embodiment, it is arranged to pay particular attention to the amount of data which is stored in a segment (=the proportion of the segment size occupied by the data size=the data load ratio), and to leave segments which include more valid data preferentially in the cache.

FIG. 4 is an explanatory figure showing a method for managing the data stored in the cache memory. In order to be able to search the data which is stored in the cache memory 132 efficiently, the storage control device 10 manages it according to the following layered structure.

First, when an I/O request is issued from the host 30, the microprocessor package 120 obtains a VDEVSLOT number (VDEVSLOT#) on the basis of the LBA (Logical Block Address) which is included in this I/O request.

And, on the basis of this VDEVSLOT number, the microprocessor package 120 refers to a VDSLOT-PAGE table T11, and acquires a pointer to the next layer. A pointer to a PAGE-DIR table T12, which is the next table, is included in the VDSLOT-PAGE table T11.

A pointer to a PAGE-GRPP table T13 is included in the PAGE-DIR table T12. Moreover, a pointer to a GRPT1 table T14 is included in the PAGE-GRPP table T13. And a pointer to a GRPT2 table T15 is included in the GRPT1 table T14. Finally, a pointer to a SLCB table T16 (a slot control table) is included in the GRPT2 table T15.

The SLCB table T16 is reached by successively referring to these various tables T11 through T15 on the basis of the LBA. At least one or more SGCB tables T17 (segment control block tables) are established in correspondence to this SLCB table T16. These SGCB tables T17 store control information related to segments 1321, which are the minimum units in cache management. One to four segments 1321 can be put into correspondence with a single slot. For example, 64 KB of data may be stored in a single segment 1321.

Although the minimum unit for cache management is a segment, state transition between the dirty data state (data in its state of not yet having been written to a storage device 151) and the clean data state (data in its state of having already been written to a storage device 151) is performed in units of slots. Taking (i.e. reserving) and also releasing (i.e. releasing or replacing) cache regions may be performed in units of slots or units of segments.

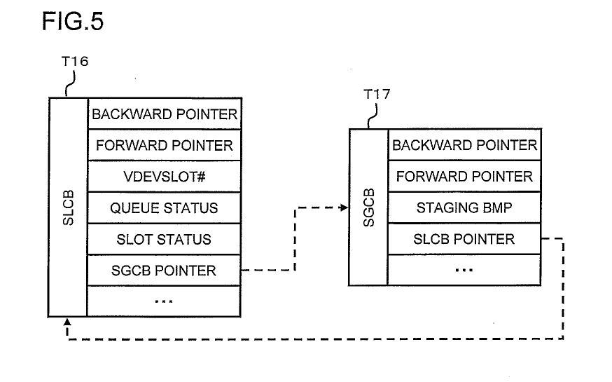

FIG. 5 is an explanatory figure showing examples of the structure of the SLCB table T16 and the SGCB table T17. As shown in FIG. 5, the SLCB table T16 may include, for example, a backward pointer, a forward pointer, a VDEVSLOT number, a queue status, a slot status, ad a SGCB pointer.

The queue status includes a queue classification and a queue number, held in this SLCB table T16 in mutual correspondence. The slot status includes the state of the slot which corresponds to this SLCB table T16. And the SGCB pointer includes a pointer for specifying the SGCB table T17 which corresponds to this SLCB table T16.

In the SGCB table T17, for example, there may be included a backward pointer, a forward pointer, a staging bitmap T1, and a SLCB pointer.

The cache algorithm will now be explained on the basis of FIGS. 6 through 10. FIG. 6 is an explanatory figure showing the case when a segment hit has occurred. Here, a segment hit means that data which is the subject of access by the host 30, and data which is stored in a segment 1321, agree with one another.

In this embodiment, the cache is controlled by using queues 101 through 103 of three types. The first queue is a high load ratio segment management queue 101 for managing segments in which a lot of data is included. The second queue is a low load ratio segment management queue 102 for managing segments in which not a great deal of data is included. And the third queue is a free queue 103 for managing segments which are unused. In the following, the abbreviated terms “high load ratio queue 101” and “low load ratio queue 102” will be employed. It should be understood that, for the convenience of depiction, the terms “high load queue” and “low load queue” are sometimes used in the drawings.

It should be understood that, for example, the high load ratio queue 101 may be termed the queue for managing segments which are kept preferentially, while the low load ratio queue 102 may be termed the queue for managing normal segments.

When a segment in which data which is the subject of access is stored is being managed with the high load ratio queue 101, this segment is shifted to be the MRU segment of the high load ratio queue 101. By contrast, when a segment in which data which is the subject of access is stored is being managed with the low load ratio queue 102, likewise, this segment is shifted to be the MRU segment of the high load ratio queue 101. In other words, in this embodiment, a segment which has been hit is subsequently managed with the high load ratio queue 101.

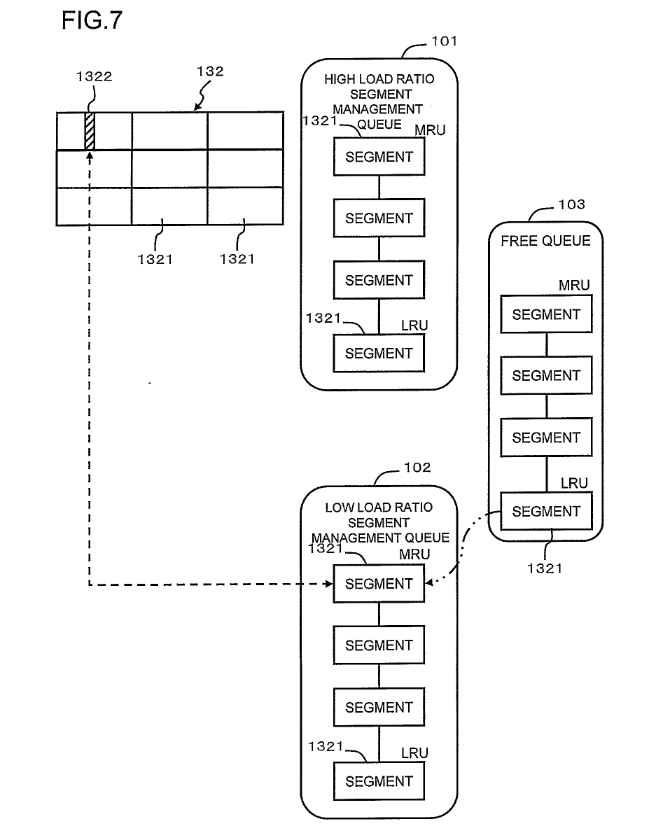

FIG. 7 is an explanatory figure showing the case when a segment miss has occurred. A segment miss means the state in which data which is the subject of access by the host 30 is stored neither in the cache memory 132, nor in any segment 1321.

If a segment miss has occurred, then, among the unused segments which are being managed with the free queue 103, that unused segment which is positioned as the LRU segment is selected, and the data which is the subject of access is stored in this segment which has been selected. And this segment in which the data which is the subject of access has been stored is shifted to become the MRU segment of the low load ratio queue 102.

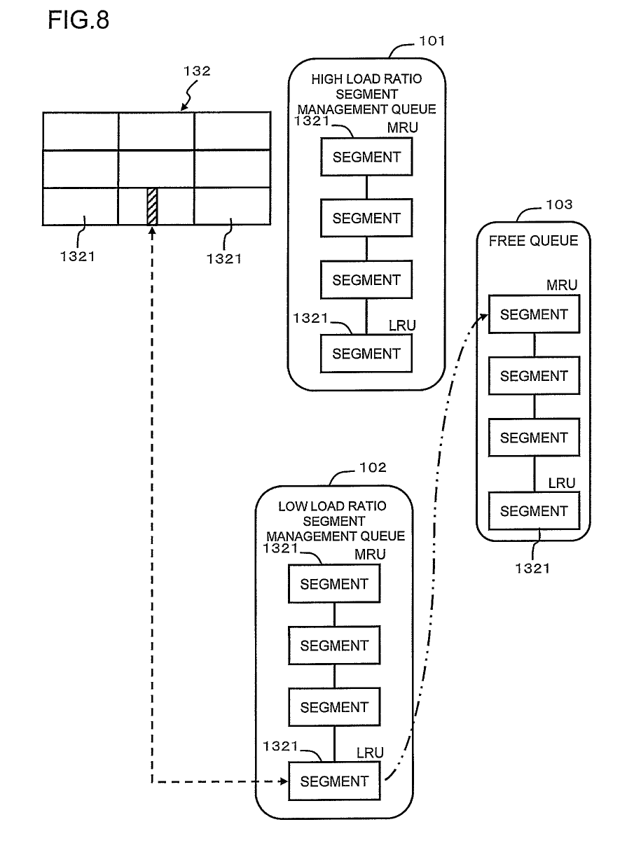

FIG. 8 shows a situation in which a segment in which data is stored is removed from the low load ratio queue and is shifted to the free queue. If the vacant capacity of the cache memory 132 has become low, then replacement of some data is performed. To put this in another manner, if the number of unused segments which are being managed with the free queue has become low, then some of the segments in which data is stored are made into unused segments, and are shifted to the free queue 103.

In this embodiment, the segment which is positioned as the LRU of the low load ratio queue 102 is shifted to be the MRU of the free queue 103, and is re-used as an unused segment.

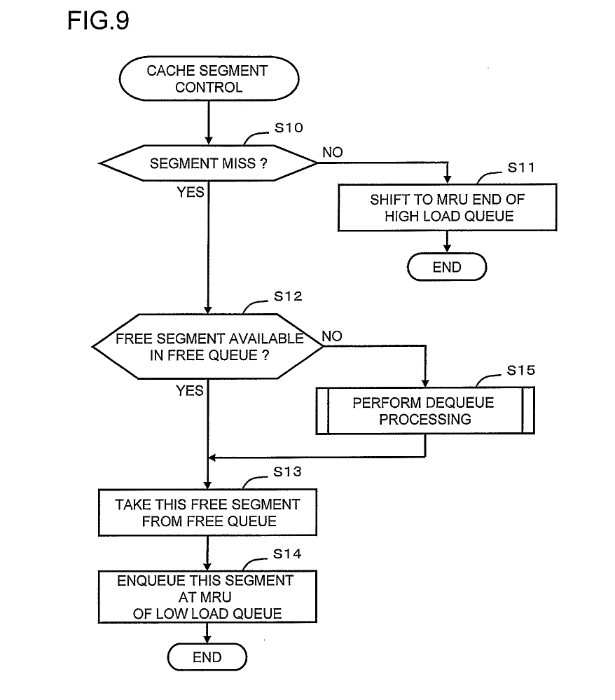

FIG. 9 is a flow chart showing processing for controlling the cache segments. It should be understood that the various flow charts shown below provide summaries of various processes as far as required for the understanding and implementation of the present invention, but may differ from the computer programs which are actually used in various ways. A person skilled in the art will be able to make various changes or alterations to the steps shown in these figures, or to add new steps or the like.

The microprocessor 121 of the microprocessor package 120 first makes a decision as to whether or not a segment miss has occurred (a step S10). If a segment hit has occurred (NO in the step S10), then the microprocessor 121 shifts this segment which has been hit to the MRU end of the high load ratio queue 101 (a step S11).

On the other hand, if a segment miss has occurred (YES in the step S10), then the microprocessor 121 makes a decision as to whether or not any unused segment is present in the free queue 103 (a step S12). If some unused segment remains (YES in the step S11), then the microprocessor 121 takes this unused segment (a step S13). And the microprocessor 121 stores the data which is the subject of access in this segment which has been taken, and then connects this segment into the low load ratio queue 102 at its MRU end (a step S14).

If no unused segment is present in the free queue 103 (NO in the step S12), then the microprocessor 121 performs dequeue processing (a step S15).

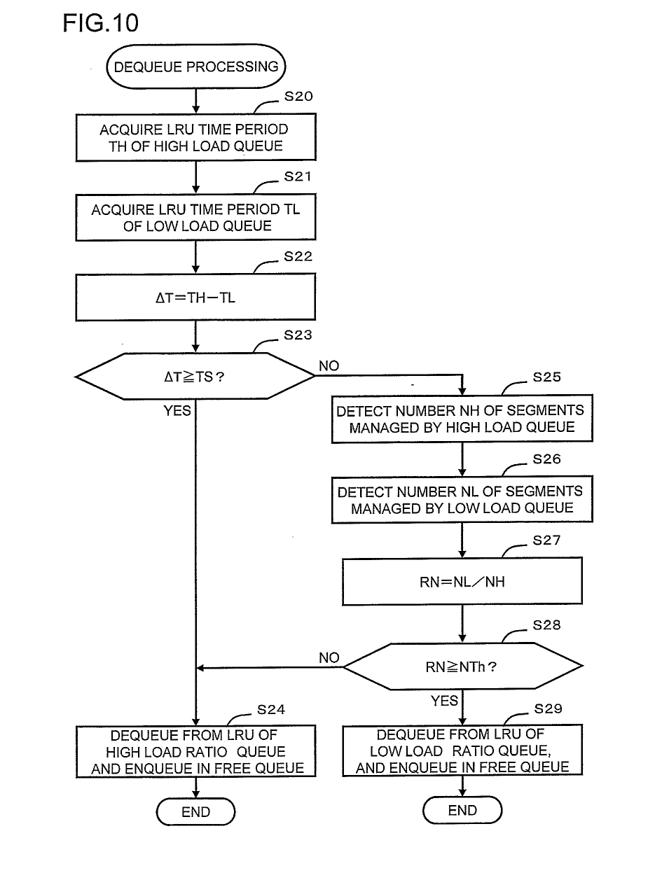

FIG. 10 is a flow chart showing this dequeue processing which is performed during the step S15 of FIG. 9. In this processing, fundamentally, a segment is taken from the LRU end of the low load ratio queue 102, and is shifted to the free queue 103 (a step S29).

However, if within the high load ratio queue 101 a segment is present which has been managed for a long time (YES in the step S23), or if the ratio of the length of the high load ratio queue 101 and the length of the low load ratio queue 102 is outside some fixed range (NO in the step S28), then this segment is removed from the LRU of the high load ratio queue 101 and is shifted to the free queue 103 (a step S24).

For the segment which is positioned at the LRU end of the high load ratio queue 101, the microprocessor 121 acquires its LRU time period TH (a step S20). This LRU time period is the time period which has elapsed from when this segment was positioned at the LRU end of this queue.

And, for the segment which is positioned at the LRU end of the low load ratio queue 102, the microprocessor 121 also acquires its LRU time period TL (a step S21). Then the microprocessor 121 calculates the time difference dT (delta-T) between the LRU time period TH for the high load ratio queue 101 and the LRU time period TL for the low load ratio queue 102 (a step S22).

The microprocessor 121 makes a decision as to whether or not this time difference dT is greater than or equal to a predetermined time period TS which is set in advance (a step S23). If the time difference dT is greater than or equal to the predetermined time period TS (YES in the step S23), then the microprocessor 121 removes the segment which is positioned at the LRU end of the high load ratio queue 101, and shifts it to the MRU end of the free queue 103 (a step S24). This is because the segment which is positioned at the LRU end of the high load ratio queue 101 has not been used for a longer time period than the segment which is positioned at the LRU end of the low load ratio queue 102, and it may be anticipated that it will not be used much in the future.

If the time difference dT is less than the predetermined time period TS (NO in the step S23), then the microprocessor 121 acquires the number NH of segments which are being managed with the high load ratio queue 101 (a step S25). In a similar manner, the microprocessor 121 acquires the number NL of segments which are being managed with the low load ratio queue 102 (a step S26). And the microprocessor calculates the ratio RN (=NL/NH) between the number of segments NL in the low load ratio queue 102 and the number of segments NH in the high load ratio queue 101 (a step S27).

Then the microprocessor 121 makes a decision as to whether or not this ratio RN is greater than or equal to a predetermined ratio NTh which is set in advance (a step S28). If the ratio RN is greater than or equal to the predetermined ratio NTh (YES in the step S28), then the microprocessor 121 removes the segment which is positioned in the LRU position in the low load ratio queue 102, and shifts it to the MRU position in the free queue 103 (a step S29).

However, if the ratio RN is less than the predetermined ratio NTh (NO in the step S28), then the microprocessor 121 removes the segment which is positioned in the LRU position in the high load ratio queue 101, and shifts it to the MRU position in the free queue 103 (a step S24). Since the number of segments NH in the high load ratio queue 101 is much greater than the number of segments NL in the low load ratio queue 102, accordingly a segment which is being managed with the high load ratio queue 101 is removed, in order to obtain a balance between these numbers of segments. The above completes the explanation of the method of cache memory management in this embodiment. Next, the method of processing a normal command will be explained.

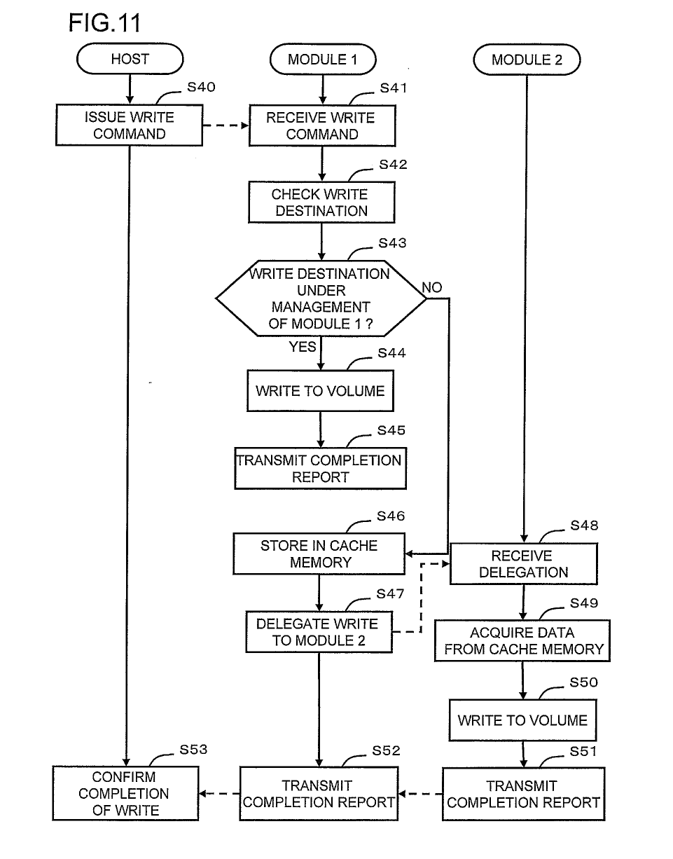

FIG. 11 shows the processing when a write command has been issued from the host 30. When the host 30 issues a write command (a step S40), the front end package 110 of the first module 100(1) receives this write command (a step S41).

The microprocessor 121 of the first module 100(1) checks the write destination of this write command (a step S42). And the microprocessor 121 makes a decision as to whether or not the write destination of the write command is a logical volume 152 which is under the management of this first module 100(1) (a step S43).

If the first module 100(1) has the logical volume 152 which is the write destination (YES in the step S43), then the microprocessor 121 writes the write data to the logical volume 152 which is the write destination, via the back end package 140 (a step S44). And then the microprocessor 121 notifies the host 30 that the write has been completed (a step S45).

But, if the write destination specified in the write command is a logical volume 152 which is being managed by the second module 100(2) (NO in the step S43), then the microprocessor 121 of the first module 100(1) stores the write data in the cache memory 132 within the first module 100(1) (a step S46). And the microprocessor 121 of the first module 100(1) delegates the processing of the write command to the micro-processor 121 of the second module 100(2) (a step S47).

When the microprocessor 121 of the second module 100(2) receives the delegation for processing the write command (a step S48), it reads out the write data from the cache memory 132 of the first module 100(1) (a step S49).

The microprocessor 121 of the second module 100(2) writes the write data to the logical volume 152 of the second module 100(2) (a step S50), and then notifies the mi-croprocessor 121 of the first module 100(1) that the write has been completed (a step S51).

When the microprocessor 121 of the first module 100(1) receives this notification from the microprocessor 121 of the second module 100(2), it notifies the host 30 that the processing of the write command has been completed (a step S52). And, by receiving this notification, the host 30 is able to confirm that the processing of the write command has been completed (a step S53).

The case of a read command is a little different, but is processed in almost a similar manner, according to the flow chart shown in FIG. 11. For reference, the way in which a read command is processed will now be explained. If the logical volume upon which the data which is the subject of being read is held by the first module 100(1), then the first module 100(1) reads out the data which has been requested from that logical volume 152 and transfers it to the cache memory 132. And the first module 100(1) transmits this read subject data to the host 30.

But, if the logical volume 152 in which the read data is stored is under the management of the second module 100(2), then the first module 100(1) delegates the processing of the read command to the second module 100(2). The second module 100(2) reads out the read subject data from the logical volume 152, and stores it in the cache memory 132 of the second module 100(2). And the second module 100(2) notifies the address which is the destination of storage of the read subject data to the first module 100(1). Then the first module 100(1) reads out the read subject data from the cache memory 132 within the second module 100(2), and transmits this data to the host 30.

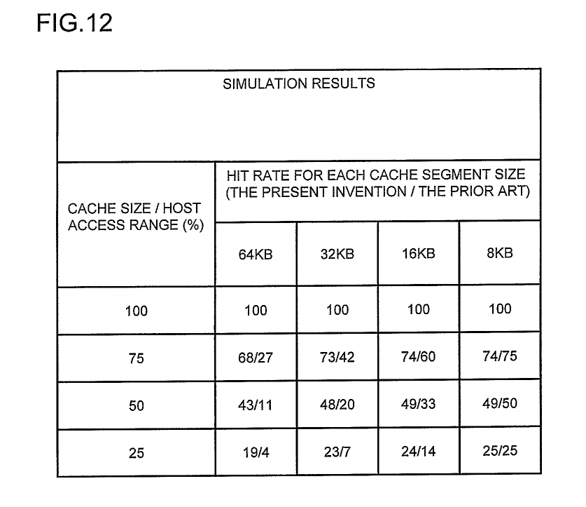

In this embodiment, as explained above, the cache segments are managed so as to retain segments in which a lot of data is stored as long as possible, while paying attention to discrepancies in the data load ratio (the staging ratio). Accordingly, as shown in FIG. 12, by increasing the efficiency of utilization of the cache memory 132, it is possible to enhance the hit rate.

FIG. 12 is a table showing the simulation results which demonstrate the benefits of this embodiment of the present invention. In “cache size/host access range” in the left column of the table there is displayed, in percent, the proportion of the range which the host accesses, which the cache size occupies. For example, “100%” means that the cache size and the host access range are equal, while “25%” means that the cache size is ¼ of the host access range.

On the right side of the table, for each size of the cache segments, the respective hit rates are shown. In this simulation, calculations have been performed for four different segment sizes: 64 KB, 32 KB, 16 KB, and 8 KB. It should be understood that the size of the accesses of the host 30 is 8 KB, and moreover it is hypothesized that the host 30 is performing accesses randomly.

If the cache size and the host access range agree with one another (i.e. if the cache size/the host access range=100%), then all of the data that can be accessed by the host 30 is stored in the cache memory 132. Accordingly in this case the hit rate is 100%, irrespective of the value of the segment size.

If the cache size is 75% of the host access range, then there are discrepancies in the hit rate, according to the relationship between the segment size and the host access size. For example, if the cache segment size is 64 KB, then the hit rate of the normal LRU algorithm becomes 27%. This is because, if the host access size (=8 KB) is too small with respect to the size of the cache segments (=64 KB), then it is not possible to utilize the cache segments effectively. However, according to the present invention, it is possible to enhance the hit rate to 68%.

In this manner, according to this embodiment, queuing is performed according to the number of data stored in the cache segments, and cache segments in which more data is stored are retained for longer times than cache segments in which the amount of data stored is low. Thus, according to this embodiment, as shown in FIG. 12, when the host access size is small as compared to the cache segment size, and when moreover the host performs random access, then it is possible to increase the efficiency of utilization of the cache memory and to enhance the hit rate

### Embodiment 2

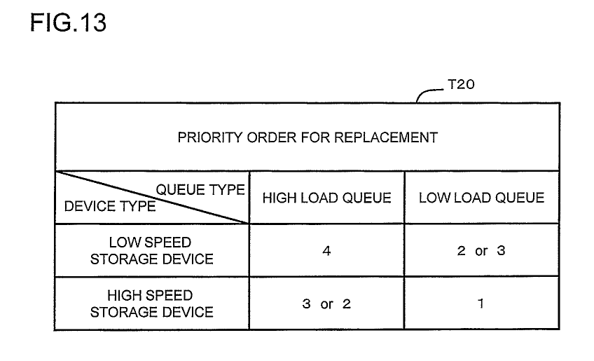

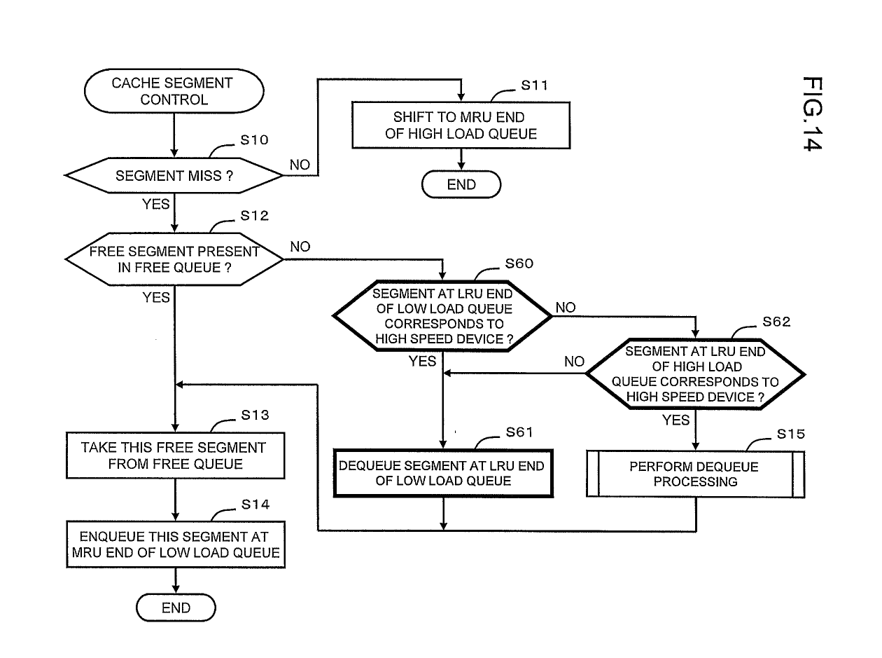

A second embodiment will now be explained on the basis of FIGS. 13 and 14. The following embodiment, including this second embodiment, are equivalent to variant embodiments of the first embodiment. Accordingly, in the following descriptions of these embodiments, the explanation will focus upon the aspects in which they differ from the first embodiment. In this second embodiment, the replacement is controlled according to the type of the storage device and the amount of data which is stored in the cache segments.

In this embodiment a mixture of high speed storage devices such as SSDs and low speed storage devices such as SATAs is used. For example, the storage control device 10 may include high speed logical volumes which are defined on the basis of SSDs and low speed logical volumes which are defined on the basis of SATAs. Or, as another example, a structure may be conceived in which one region in a logical volume is defined on the basis of an SSD, and another region is defined on the basis of a SATA.

It should be understood that, in the flow chart which is described hereinafter, for the convenience of illustration, the abbreviation “low speed devices” is used for the low speed storage devices, and the abbreviation “high speed devices” is used for the high speed storage devices.

FIG. 13 shows a table T20 for deciding a priority order for replacement, according to the type of storage device and the type of queue. If the number of unused segments which are being managed with the free queue 103 has become low, then segments which are in used are returned to being free segments, according to the priority order shown in this table T20.

Among the cache segments which correspond to high speed storage devices, those segments which are being managed with the low load ratio queue 102 are the highest ones in the priority order. And, among the cache segments which correspond to low speed storage devices, those segments which are being managed with the low load ratio queue 102 are the second (or third) ones in the priority order. Among the cache segments which correspond to high speed storage devices, those segments which are being managed with the high load ratio queue 101 are the second (or third) ones in the priority order. And, among the cache segments which correspond to low speed storage devices, those segments which are being managed with the high load ratio queue 101 are the lowest ones in the priority order.

Since the high speed storage devices are the ones whose access speeds are high, accordingly the penalty is small if a segment miss occurs. By contrast, since the low speed storage devices are the ones whose access speeds are low, accordingly the penalty is high if a segment miss occurs. Thus, in this embodiment, it is arranged to keep segments which contain more data and whose data is stored in low speed storage devices (i.e., fourth order segments) in the cache memory for as long as possible.

FIG. 14 is a flow chart showing the cache segment control procedure. If a segment miss has occurred (YES in the step S10), and there are no unused segments in the free queue 103 or if the number of unused segments is insufficient (NO in the step S12), then the microprocessor 121 makes a decision as to whether or not the segment which is positioned at the LRU end of the low load ratio queue 102 corresponds to a high speed device (a step S60).

If the segment which is positioned at the LRU end of the low load ratio queue 102 corresponds to a high speed device (YES in the step S60), then the microprocessor 121 dequeues this segment which is positioned at the LRU end of the low load ratio queue 102, and shifts it to the free queue 103 (a step S61). In other words, the microprocessor 121 changes the status of the segment of the first order shown in FIG. 13 to the free state (the step S61).

On the other hand, if the segment which is positioned at the LRU end of the low load ratio queue 102 does not correspond to a high speed device (NO in the step S60), then the microprocessor 121 makes a decision as to whether or not the segment which is positioned at the LRU end of the high load ratio queue 101 corresponds to a high speed ratio storage device (a step S62).

If the segment which is positioned at the LRU end of the high load ratio queue 101 corresponds to a high speed device (YES in the step S62), then the flow of control is transferred to the step S61, and dequeues the segment which is positioned at the LRU end of the low load ratio queue 102. In other words, in this case, this segment which is positioned at the LRU end of the low load ratio queue 102, and which corresponds to a low speed storage device, is dequeued.

Thus, if the segment which is positioned at the LRU end of the high load ratio queue 101 corresponds to a high speed device (YES in the step S62), then the dequeue processing described in FIGS. 9 and 10 is performed (the steps S15 and S20 through S29).

With this second embodiment having the structure described above, a similar ad-vantageous effect is obtained as in the case of the first embodiment. In addition thereto, with this second embodiment, since the replacement is performed according to the access speeds of the storage devices, accordingly it is possible to leave segments which are in low speed storage devices and which contain a lot of data in the cache memory for comparatively long periods of time.

### Embodiment 3

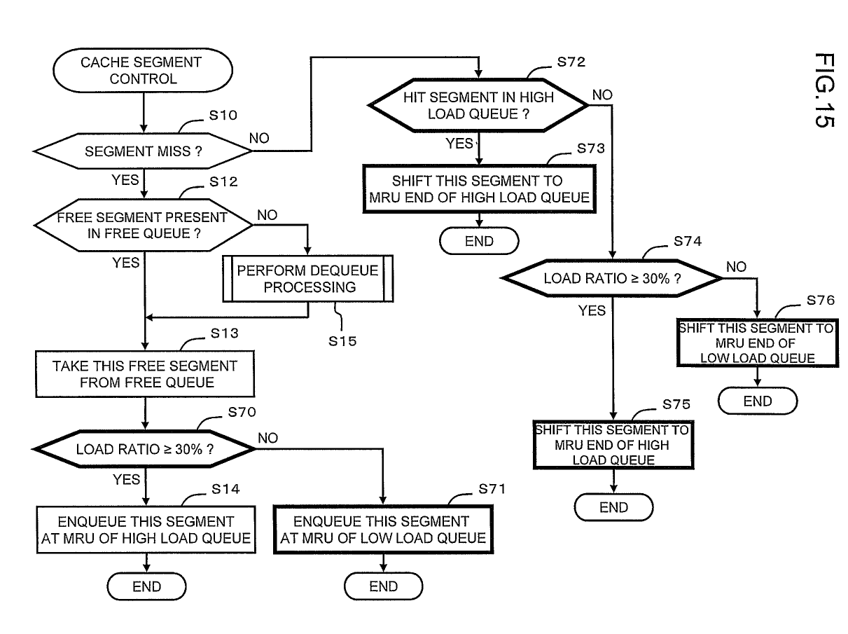

A third embodiment will now be explained on the basis of FIG. 15. In this third em-bodiment, the queuing is performed according to the amounts of data stored in the segments (i.e., the data load ratios).

FIG. 15 is a flow chart showing the cache segment control procedure. If a segment miss has occurred (YES in the step S10), and moreover there are enough unused segments present in the free queue 103 (YES in the step S12), then the microprocessor 121 selects an unused segment and stores the write data in it.

The microprocessor 121 selects a segment to be connected into a queue according to the amount of data stored in the segment (a step S70). And the microprocessor 121 makes a decision as to whether or not the amount of data which the amount of data which is stored in this segment is greater than or equal to 30% of the segment size (the step S70). In this specification, the proportion of the amount of data which is stored in a segment to the size of that segment is termed the “data load ratio”. The data load ratio may be obtained by referring to the staging bitmap T1.

If the data load ratio is greater than or equal to 30% (YES in the step S70), then the microprocessor 121 positions this segment in which the data is stored at the MRU end of the high data load ratio queue 101 (a step S14). By contrast, if the data load ratio is less than 30% (NO in the step S70), then the microprocessor 121 positions this segment in which the data is stored at the MRU end of the low data load ratio queue 102 (a step S71).

If a segment hit has occurred (NO in the step S10), then the microprocessor 121 makes a decision as to whether or not the segment which has been hit is being managed with the high data load ratio queue 101 (a step S72). If this segment is being managed with the high data load ratio queue 101 (YES in the step S72), then the mi-croprocessor 121 shifts this segment to the MRU end of the high data load ratio queue 101 (a step S73).

But, if the segment which has been hit is being managed with the low data load ratio queue 102 (NO in the step S72), then the microprocessor 121 makes a decision as to whether or not the data load ratio of this segment is greater than or equal to 30% (a step S74).

If the data load ratio is greater than or equal to 30% (YES in the step S74), then the microprocessor 121 positions this segment at the MRU end of the high data load ratio queue 101 (a step S75). But, if the data load ratio is less than 30% (NO in the step S74), then the microprocessor 121 positions this segment at the MRU end of the low data load ratio queue 102 (a step S76).

With this third embodiment having the structure described above, a similar ad-vantageous effect is obtained as in the case of the first embodiment. In addition thereto, with this third embodiment, since the data load ratios of the segments are detected by referring to the staging bitmap T1, accordingly it is possible to use the high data load ratio queue 101 and the low data load ratio queue 102 separately on the basis of the staging mode. It should be understood that the 30% above is only one example of the threshold value; the present invention should not be considered as being limited by this value of 30%.

### Embodiment 4

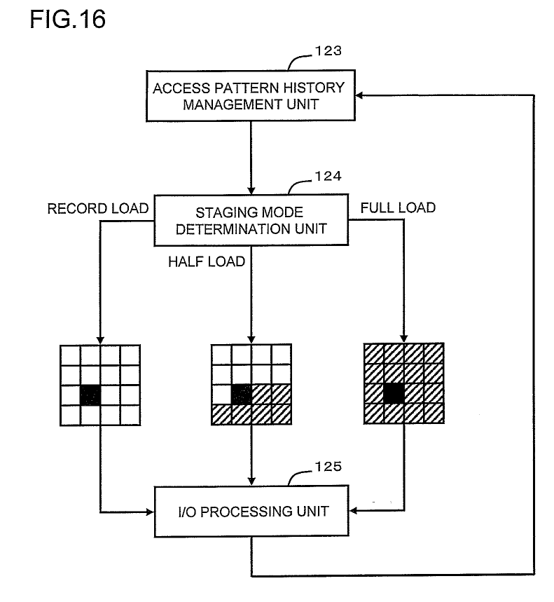

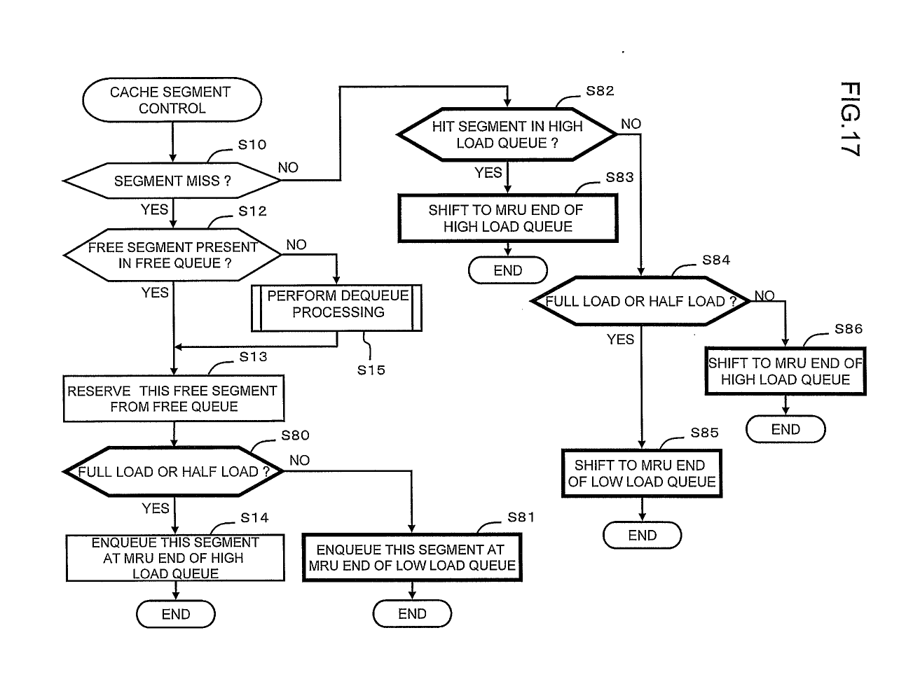

A fourth embodiment will now be explained on the basis of FIGS. 16 and 17. In this fourth embodiment, usage is divided between the high data load ratio queue 101 and the low data load ratio queue 102, according to the type of staging mode (transfer mode) by which the data is transferred from the storage device 151 to the cache memory 132.

FIG. 16 is an explanatory figure, schematically showing this staging mode. In this embodiment, three different staging modes may be used: record load, half load, and full load.

Record load, which is a “first mode”, is a mode in which only a record (i.e. a sub-block) which has been requested is staged. Half load, which is a “second mode”, is a mode in which data within the segment to which the requested record belongs, from that record up to the final record, is staged. And full load, which is a “third mode”, is a mode in which all of the data in the segment to which the requested record belongs is staged.

An access pattern history management unit 123 functions for managing the history of the access pattern of the host 30. This staging mode determination unit 124 functions for determining the staging mode, and determines any one among the three staging modes described above, on the basis of the history of the access pattern. And data is transferred from the storage devices 151 to the cache memory 132 according to the staging mode which has thus been confirmed.

And an I/O (Input/Output) processing unit 125 performs processing of commands from the host 30, using the data which is stored in the cache memory 132.

FIG. 17 is a flow chart showing the cache segment control procedure. If a segment miss has occurred (YES in the step S10), then, from among the unused segments which are being managed with the free queue 103, the microprocessor 121 reserves only the necessary unused segments (YES in the step S12, and the step S13).

And the microprocessor 121 makes a decision as to whether or not the current staging mode is full load or half load (a step S80). If the current staging mode is either full load or half load (YES in the step S80), then the microprocessor 121 positions the segment in which the data is stored at the MRU end of the high data load ratio queue 101 (a step S14). Since a segment from which data has been read out at full load or half load is one in which a lot of data is stored, accordingly it is managed with the high data load ratio queue (the step S14).

By contrast, if the current staging mode is record load (NO in the step S80), then the microprocessor 121 positions the segment in which the data is stored at the MRU end of the low data load ratio queue 102 (a step S81). Since, in the case of record load, only the data which has been requested is staged, accordingly it is considered that the proportion of the segment which the data occupies (in other words, the data load ratio) is comparatively small. Accordingly, this segment is managed with the low data load ratio queue 102 (a step S81).

If there has been a segment hit (NO in the step S10), then the microprocessor 121 makes a decision as to whether or not the segment which has been hit is being managed with the high data load ratio queue 101 (a step S82). And, if this segment which has been hit is being managed with the high data load ratio queue 101 (YES in the step S82), then the microprocessor 121 positions this segment at the MRU end of the high data load ratio queue 101 (a step S83).

But, if the segment which has been hit is being managed with the low data load ratio queue 102 (NO in the step S82), then the microprocessor 121 makes a decision as to whether or not the staging mode in relation to this segment which has been hit is either full load or half load (a step S84).

If the staging mode related to this segment is either full load or half load (YES in the step S84), then the microprocessor 121 positions this segment at the MRU end of the high data load ratio queue 101 (a step S85). But, if the staging mode related to this segment is record load (NO in the step S84), then the microprocessor 121 positions this segment at the MRU end of the low data load ratio queue 102 (a step S86).

With this fourth embodiment having the structure described above, a similar ad-vantageous effect is obtained as in the case of the first embodiment. In addition thereto, with this fourth embodiment, since the high data load ratio queue 101 and the low data load ratio queue 102 are used separately on the basis of the staging mode, accordingly it is possible to simplify the structure, as compared to the method of referring to a staging bitmap T1.

### Embodiment 5

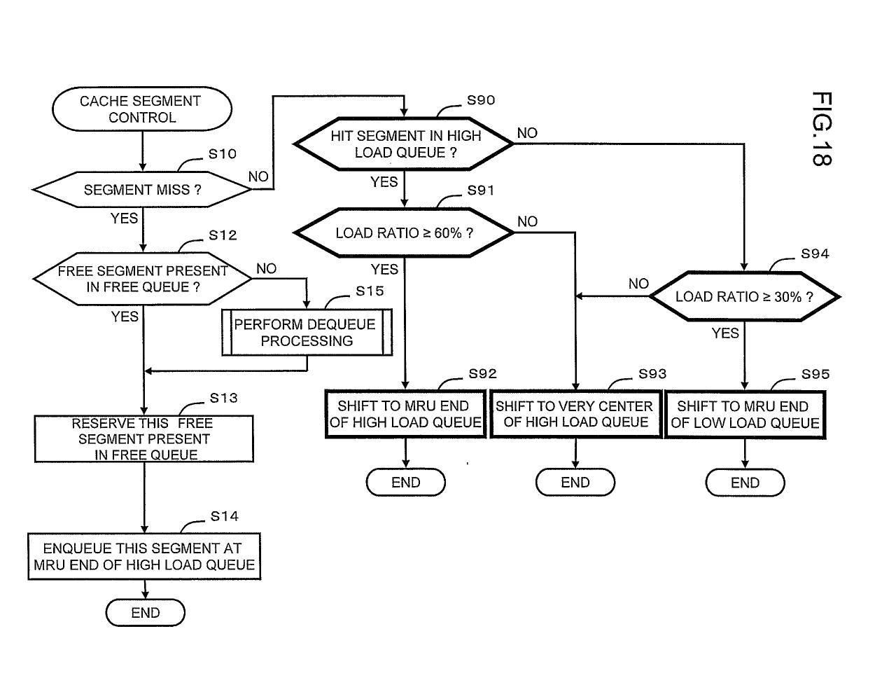

A fifth embodiment will now be explained on the basis of FIG. 18. In this fifth em-bodiment, if the segment which has been hit is being managed with the high data load ratio queue 101 (YES in a step S90), then, if the data load ratio of this segment is less than a first threshold value (for example, 60%) (NO in a step S91), then this segment is positioned, not to the MRU end of the high data load ratio queue 101, but rather to an intermediate position in the high data load ratio queue 101 (a step S93).

FIG. 18 is a flow chart of this cache segment control procedure. If a segment hit has occurred (NO in the step S10), then the microprocessor 121 makes a decision as to whether or not the segment which has been hit is being managed with the high data load ratio queue 101 (a step S90).

If the segment which has been hit is being managed with the high data load ratio queue 101 (YES in the step S90), then the microprocessor 121 makes a decision as to whether or not the data load ratio of this segment is greater than or equal to 60% (a step S91). It should be understood that this first threshold value is not limited to being 60%; some other value would also be acceptable.

If the data load ratio is less than 60% (NO in the step S91), then the microprocessor 121 positions this segment at an intermediate position in the high load ratio queue 101 (for example, at the very center of this queue) (a step S93). Due to this, a segment for which the effective data amount which is stored is small (i.e. a segment for which the data load ratio is small) does not become positioned at the MRU end of the high load ratio queue 101, even if it is a segment which is being managed with the high load ratio queue 101.

On the other hand, if the segment which has been hit is being managed with the low load ratio queue 102 (NO in the step S90), then the microprocessor 121 makes a decision as to whether or not the data load ratio of this segment is greater than or equal to 30% (a step S94). And, if the data load ratio is greater than or equal to 30% (YES in the step S94), then the microprocessor 121 shifts this segment from the low load ratio queue 102 to an intermediate position in the high load ratio queue 101 (a step S93).

On the other hand, if the data load ratio is less than 30% (NO in the step S94), then the microprocessor 121 positions this segment at the MRU end of the low load ratio queue 102 (a step S95).

With this fifth embodiment having the structure described above, a similar ad-vantageous effect is obtained as in the case of the first embodiment. In addition thereto, with this fifth embodiment, in the case of a segment hit, the position in the queue is changed according to the data load ratio of that segment. Accordingly it is possible to perform queuing in a more detailed manner.

### Embodiment 6

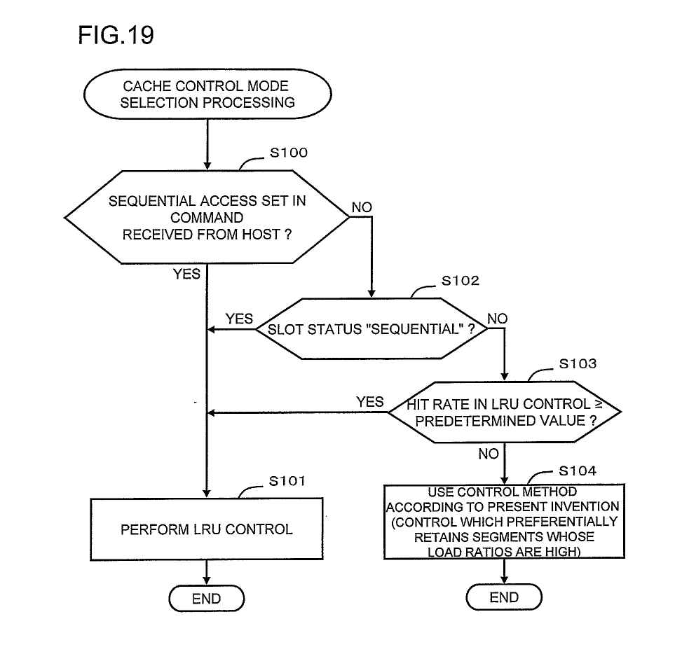

A sixth embodiment will now be explained on the basis of FIG. 19. In this sixth em-bodiment, different cache algorithms are used when access by the host 30 is sequential access, and when it is random access.

FIG. 19 is a flow chart showing processing for selecting the cache control mode (i.e. the cache control algorithm). The microprocessor 121 analyzes the command which it has received from the host 121, and determines whether or not sequential access is set in that command (a step S100). In other words, the microprocessor 121 decides whether or not the access by the host 30 is sequential access, by analyzing the command received from the host 30.

If it has been decided that the access is sequential access (YES in the step S100), then the microprocessor 121 selects normal LRU control (a step S101). In other words, in this normal LRU control, if the number of unused segments has become low, then the segment which is positioned at the LRU end is returned to the heap of unused segments.

But if sequential access is not set within the command received from the host 30 (NO in the step S100), then the microprocessor 121 makes a decision as to whether or not the slot status shown in FIG. 5 is set to “sequential” (a step S102). For example if it has been decided by an algorithm which learns the access pattern that sequential access is taking place, then “sequential” is set in the slot status.

If the slot status is set to sequential (YES in the step S102), then the flow of control is transferred to the step S101 and normal LRU control is selected (the step S101). But, if the slot status is not set to sequential, then the microprocessor 121 makes a decision as to whether or not the hit rate by normal LRU control is greater than or equal to a predetermined value which is set in advance (a step S103).

If the hit rate during LRU control is greater than or equal to the predetermined value (YES in the step S103), then the microprocessor 121 decides that sequential access is taking place, and the flow of control is transferred to the step S101. But, if the hit rate during LRU control is less than the predetermined value (NO in the step S103), then the microprocessor 121 selects control as described with reference to the first em-bodiment of the present invention. In other words, in the case of random access, control is performed so as preferentially to retain segments whose data load is high.

It should be understood that the action at this stage is not limited to being processing according to the first embodiment; in this step S104, it would also be acceptable to arrange to select control according to some other embodiment of the present invention.

With this sixth embodiment having the structure described above, a similar ad-vantageous effect is obtained as in the case of the first embodiment. In addition thereto, with this sixth embodiment, normal LRU control is selected during sequential access, and cache control according to the present invention is selected during random access. Accordingly it is possible to select a control method which is well adapted to the access pattern of the host 30.

### Embodiment 7

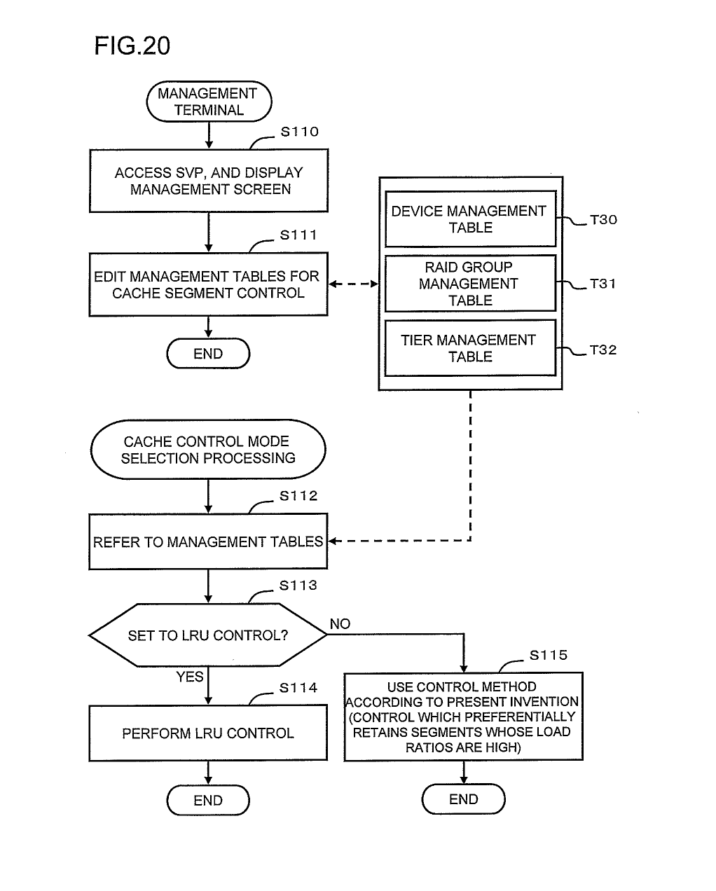

A seventh embodiment will now be explained on the basis of FIGS. 20 through 23. In this seventh embodiment, it is possible for the user to specify in advance, from the management terminal 20, whether normal LRU control is to be performed, or the special cache control according to the present invention is to be performed.

FIG. 20 is a flow chart showing processing which the user executes using the management terminal 20, for setting a control mode for each logical volume. The user accesses the SVP 160 via the management terminal 20, and causes the management screen to be displayed (a step S110).

Via the management screen, the user edits various cache segment control management tables T30 through T32 as appropriate, and stores them (a step S111). These cache management tables T30 through T32 will be described hereinafter.

The microprocessor 121 refers to these management tables T30 through T32 (a step S112), and makes a decision as to whether or not normal LRU control is set as the cache control mode (a step S113).

If normal LRU control is set (YES in the step S113), then the microprocessor 121 performs normal LRU control (a step S114). But, if the control method according to the present invention is selected (NO in the step S113), then, as described in connection with the various embodiments, control is performed so as preferentially to retain segments whose data load ratios are high (a step S115).

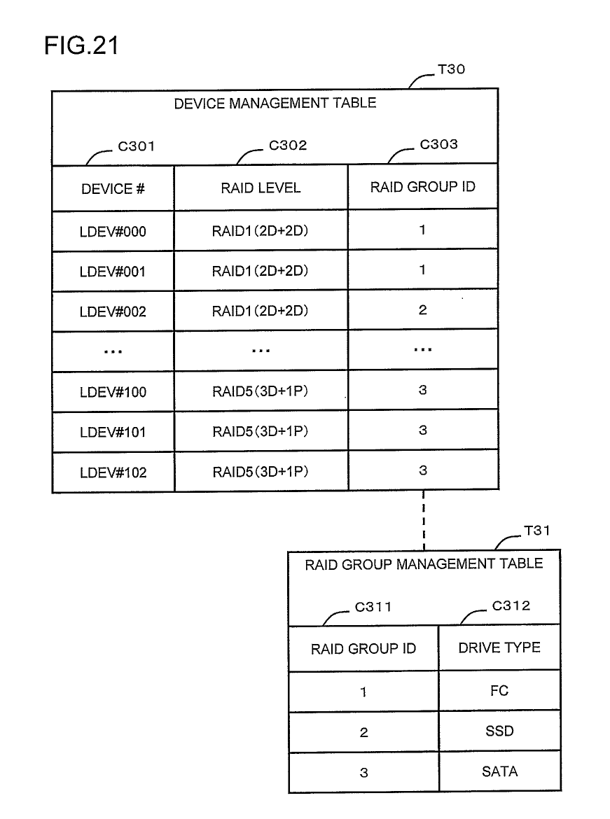

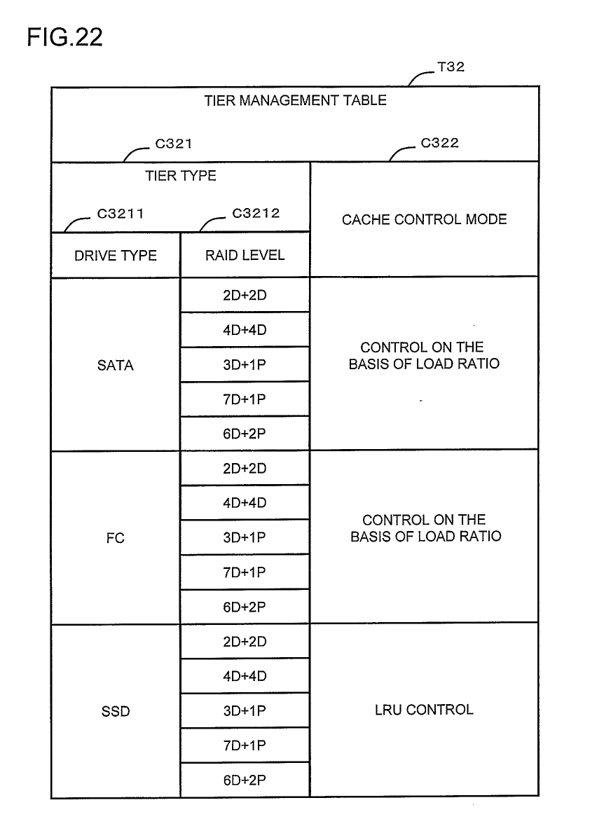

Examples of the structures of the management tables T30 through T32 will now be explained with reference to FIGS. 21 and 22. FIG. 21 is an explanatory figure showing the device management table T30 and the RAID group management table T31.

The device management table T30 is a table for management of the structure of the logical volumes 152, which are logical storage devices. This device management table T30, for example, may perform its management by maintaining, in mutual corre-spondence, device numbers C301, RAID levels C302, and RAID group IDs C303.

The device numbers C301 are information for identifying the logical volumes 152 which belong to this storage device 10. The RAID levels C302 are information specifying the RAID structures which are applied to these logical volumes 152. And the RAID group IDs C303 are information for identifying the RAID groups 150 to which the various logical volumes 152 belong.

The RAID group management table T31 is a table for management of the RAID groups 150. This RAID group management table T31, for example, may perform its management by maintaining, in mutual correspondence, RAID group IDs C311 and drive types C312. The RAID group IDs C311 are the same as the RAID group IDs C303 which are managed by the device management table T30. And the drive types C312 are information which specifies the types of the storage devices 151 which belong to the RAID groups 150.

FIG. 22 is an explanatory figure showing the tier management table T32. This tier management table T32 is a table for managing each storage layer which the storage control device 10 possesses. The tier management table T32, for example, may perform its management by maintaining, in mutual correspondence, tier types C321 and cache control modes C322.

The tier types C321 define the tier types as combinations of drive types C3211 and RAID levels C3212. The drive types may be, for example, SATA, FC, SSD, or the like. The RAID levels may be, for example, RAID 1, RAID 5, RAID 6, or the like. Moreover, in the case of RAID 1, there is a difference according to whether the drive structure is 2D+2D or 4D+4D. It should be understood that, in the second column of this table T32, “D” means “data drive”, and “P” means “parity drive”.

The cache control mode to be applied to each tier is set in the cache control mode C322. The cache control mode either may be a mode in which, as explained above in connection with the various embodiments of the present invention, segments whose data load ratio is high are retained within the cache memory for as long as possible, or may be a mode in which normal LRU is performed.

It should be understood that the control method of the present invention (i.e. the control mode) is not to be considered as being limited by the structure of the first em-bodiment, and it could be: a method of determining the order of replacement according to the type of the storage device 151 (as in the second embodiment); a method of dividing the segments between two queues 101 and 102 according to the data load ratio (as in the third embodiment); a method of dividing the segments between two queues 101 and 102 according to the staging mode (as in the fourth embodiment); a method of, upon a segment hit, shifting the segment to an intermediate position in the queue 101 (as in the fifth embodiment); a method of changing over between performing normal LRU control during sequential access, and applying a control method according to the present invention during random access (as in the sixth embodiment); a method of using three queues as will be described hereinafter (as in the eighth embodiment); or a method of setting a plurality of regions within a single queue as will be described hereinafter (in the ninth embodiment). According to requirements, the user may also set different ones of the control methods described above, individually for each tier.

Furthermore, while in FIG. 22 a case was shown in which the cache control mode was set for each tier unit individually, this should not be considered as being limitative of the present invention; it would also be acceptable to arrange to set the cache control mode individually for each of the logical volumes 152.

Moreover, as has been described above in connection with the sixth embodiment of the present invention, it would also be acceptable to arrange to decide automatically, according to the pattern of access by the host 30, whether to employ the normal LRU control mode or to employ the control mode according to the present invention, and to register this decision result in advance in the tier management table T32. The user would also be able manually to change the control mode which has been registered in advance.

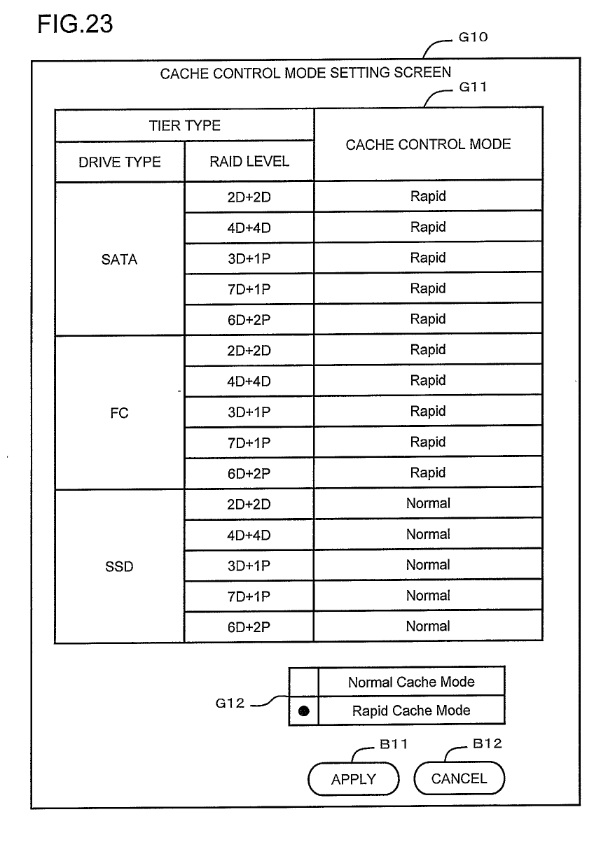

FIG. 23 is an explanatory figure showing a setting screen G10 for the cache control mode, which is displayed upon the screen of the management terminal 20. Via this setting screen G10, the user is able manually to set the cache control mode for each tier type.

The setting screen G10 may include, for example, a list display unit G11 which shows the cache control mode for each tier type, a designation unit G12 for selecting either normal LRU control (“Normal Cache Mode”) or the control method according to the present invention (“Rapid Cache Mode”), and an “apply” button B11.

With this seventh embodiment having the structure described above, a similar ad-vantageous effect is obtained as in the case of the first embodiment. In addition thereto, with this seventh embodiment the convenience of use is enhanced, since it is possible for the user to set the cache control mode in advance.

### Embodiment 8

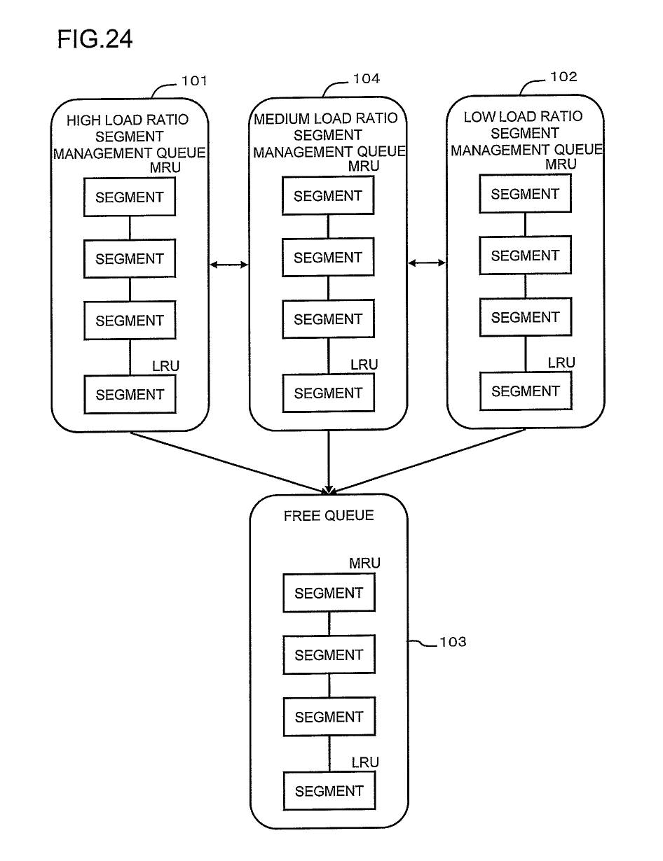

A eighth embodiment will now be explained on the basis of FIG. 24. In this eighth embodiment, a high load ratio queue 101, a low load ratio queue 102, a free queue 103, and a medium load ratio queue 104 are used. In other words, the three type of queue 101, 102, and 104 are used for managing the segments which are in use.

The medium load ratio queue 104 is a queue for managing those segments which have data load ratios which are intermediate between the data load ratios which correspond to the high load ratio queue 101 and the data load ratios which correspond to the low load ratio queue 102. In this manner, with this eighth embodiment having the structure described above, a similar advantageous effect is obtained as in the case of the first embodiment.

### Embodiment 9

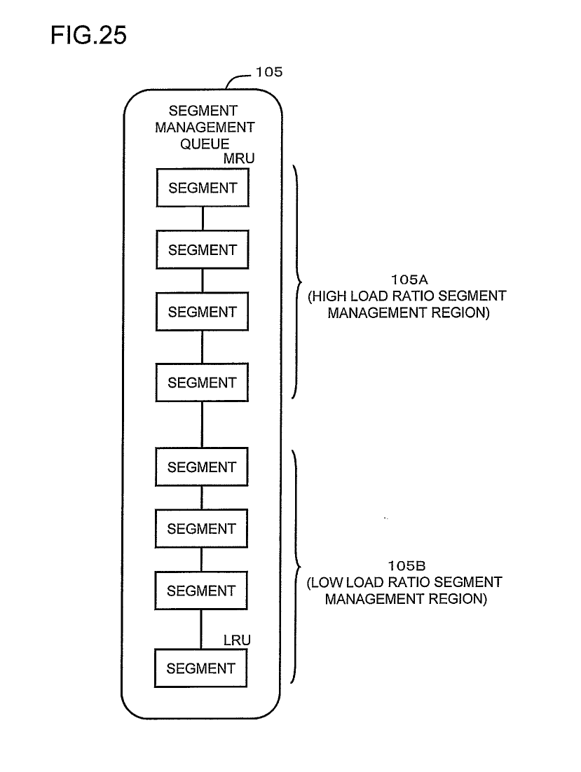

A ninth embodiment will now be explained on the basis of FIG. 25. In this ninth em-bodiment, one queue 105 is used by being divided into two regions 105A and 105B. One of these regions 105A is a region for managing segments whose data load ratio is high. The other of these regions 105B is a region for managing segments whose data load ratio is low. It should be understood that the unused segments are managed with the free queue 103. In this manner, with this ninth embodiment having the structure described above, a similar advantageous effect is obtained as in the case of the first embodiment.

It should be understood that the present invention is not limited to the embodiments described above. A person skilled in the art will be able to make various additions and alterations within the scope of the present invention. For example, it would be possible to combine the above embodiments in various appropriate ways.

1. A storage control device (1, 10) which performs data input and output between a host computer (2, 30) and a storage device (5, 151) via a cache memory (4, 132), comprising:
a cache control unit (120) for controlling data input and output to and from a plurality of segments (4A, 1321) which said cache memory possesses; and a plurality of queues (101-103) which are used by said cache control unit for managing said segments;
wherein, in predetermined circumstances, by controlling said queues according to the amounts of data stored in said segments, said cache control unit permutes segments in which said data amounts are relatively small, so as to give priority to segments whose data amounts are relatively large.

2. A storage control device according to claim 1, wherein:
said plurality of queues includes a first queue (6, 101) for managing segments in which the amount of data is relatively large, a second queue (7, 102) for managing segments in which the amount of data is relatively small, and a third queue (8, 103) for managing unused segments;
said predetermined circumstances are that the size of accesses by said host computer is smaller than the size of said segments, and moreover that said host computer performs random accesses; and
said cache control unit:
if data requested by said host computer is not stored in any of said segments, stores said data requested by said host computer in an unused segment which is being managed with said third queue, and manages said segment with said second queue;
if said data requested by said host computer is stored in one of said segments, manages the segment in which said data is stored with said first queue; and
if the number of said unused segments which are being managed with said third queue has become less than or equal to a predetermined value, manages with said third queue as an unused segment, that segment, among said segments being managed with said second queue, for which the elapsed time from its last use is the longest.

3. A storage control device according to claim 1, wherein said predetermined cir-cumstances are that the size of accesses by said host computer is smaller than the size of said segments, and moreover that said host computer performs random accesses.

4. A storage control device according to claim 1, wherein said plurality of queues includes a first queue for managing segments in which the amount of data is relatively large, a second queue for managing segments in which the amount of data is relatively small, and a third queue for managing unused segments.

5. A storage control device according to claim 4, wherein one single queue 105 is divided into two regions (105A) and (105B), and said first region is used as said first queue, while said second region is used as said second queue.

6. A storage control device according to claim 1, wherein said cache control unit:
if data requested by said host computer is not stored in any of said segments, stores said data requested by said host computer in an unused segment which is being managed with said third queue, and manages said segment with said second queue as the segment which has been most recently used; and
if said data requested by said host computer is stored in one of said segments, manages the segment in which said data is stored with said first queue as the segment which has been used the longest ago.

7. A storage control device according to claim 6, wherein, if the number of said unused segments which are being managed with said third queue has become less than or equal to a predetermined value, said cache control unit manages with said third queue, as an unused segment, that segment, among said segments being managed with said second queue, for which the elapsed time from its last use is the longest.

8. A storage control device according to claim 6, wherein, if the number of said unused segments which are being managed with said third queue has become less than or equal to a predetermined value, said cache control unit:
compares together a first elapsed time of that segment, among the segments stored in said first queue, which has been used the longest ago, and a second elapsed time of that segment, among the segments stored in said second queue, which has been used the longest ago; and:
if said first elapsed time is greater than or equal to said second elapsed time, manages with said third queue, as an unused segment, said segment, among said segments being managed with said first queue, which has been used the longest ago; and
if said first elapsed time is less than said second elapsed time, manages with said third queue, as an unused segment, said segment, among said segments being managed with said second queue, which has been used the longest ago.

9. A storage control device according to claim 6, wherein, if the number of said unused segments which are being managed with said third queue has become less than or equal to a predetermined value, said cache control unit calculates the ratio between the number of segments which are being managed with said first queue, and the number of segments which are being managed with said second queue; and manages with said third queue, as an unused segment, either that segment, among said segments being managed with said first queue, which has been used the longest ago, or that segment, among said segments being managed with said second queue, which has been used the longest ago, so that said ratio approaches a target ratio which is set in advance.

10. A storage control device according to claim 6, wherein said storage device includes a high speed storage device whose access speed is relatively high and a low speed storage device whose access speed is relatively low; and, if the number of said unused segments being managed with said third queue is less than or equal to a predetermined value, said cache control unit manages with said third queue, as an unused segment, a segment, among said segments being managed with said second queue, which corresponds to said high speed storage device.

11. A storage control device according to claim 1, wherein said cache control unit:
if the amount of data which is stored in segments being managed with said first queue has dropped below a predetermined value which is set in advance, shifts said segment in which the amount of data has dropped below said predetermined value to said second queue; and
if the amount of data which is stored in segments being managed with said second queue is greater than said predetermined value which is set in advance, shifts said segment in which the amount of data is greater than or equal to said predetermined value to said first queue.

12. A storage control device according to claim 1, wherein:
each of said segments consists of a plurality of blocks;
each of said blocks consists of a plurality of sub-blocks;
when predetermined data which has been requested from said host computer is not stored in any one of said segments, said cache control unit reads out said pre-determined data from said storage device according to either a first mode, a second mode, or a third mode;
said first mode is a mode in which only data in a sub-block corresponding to said predetermined data is read out from said storage device and stored in said cache memory;
said second mode is a mode in which data from a sub-block corresponding to said predetermined data to the final sub-block in the segment which contains said sub-block is read out from said storage device and stored in said cache memory; and
said third mode is a mode in which the data in all of the sub-blocks in the segment which contains a sub-block corresponding to said predetermined data is read out from said storage device and stored in said cache memory; and
said cache control unit:
if said predetermined data has been read out in said first mode, manages the segment in which said predetermined data is stored with said second queue; and
if said predetermined data has been read out in said second mode or said third mode, manages the segment in which said predetermined data is stored with said first queue.

13. A storage control device according to claim 1, wherein, in other than said prede-termined circumstances, said cache control unit releases and reuses segments, among said segments, in order from that segment for which the elapsed time since its last use is the longest.

14. A control method for a cache memory, for performing data input and output between a host computer (2, 30) and a storage device (5, 151) via a cache memory (4, 132), wherein:
the size of accesses by said host computer is smaller than the size of segments (4A, 1321) which make up said cache memory;
a decision is made as to whether or not data to which access has been requested from said computer is stored in any of said segments;
if said data to which access has been requested from said computer is stored in one of said segments, said segment in which said data is stored is shifted to a first queue (6, 101) for managing segments in which the proportion of data which has been staged is relatively large;
if said data to which access has been requested from said computer is not stored in one of said segments, a decision is made as to whether or not any unused segment exists;
if such an unused segment exists, said data to which access has been requested from said computer is read out from said storage device and stored therein, and said segment in which said data which has been read out from said storage device has been stored is put at the newest end of a second queue (7, 102) for managing segments in which the proportion of data which has been staged is relatively small; and
if such an unused segment does not exist, then either that segment, among the segments which are being managed with said first queue, for which the elapsed time from last access is the longest, or that segment, among the segments which are being managed with said second queue, for which the elapsed time from last access is the longest, is used as said unused segment.
